(19) United States
(12) Patent Application Publication
(10) Pub. No.: US 2026/0195356 A1
(43) Pub. Date: Jul. 9, 2026

(54) GENERATING DATA BRIEFS USING GENERATIVE MACHINE LEARNING MODELS

(71) Applicant: Prudentia Sciences, Inc., Belmont, MA (US)

(72) Inventors: John Van Wicheren Reynders, III, Newton, MA (US); Sadiqa Mahmood, Belmont, MA (US); Wasim Malik, Boston, MA (US)

(21) Appl. No.: 19/443,982

(22) Filed: Jan. 8, 2026

Related U.S. Application Data
(60) Provisional application No. 63/743,188, filed on Jan. 8, 2025.

(51) Int. Cl. G06F 16/3329; G06F 16/34; G06N 20/00

(52) U.S. Cl. CPC G06F 16/33295; G06F 16/34; G06N 20/00

(57) ABSTRACT

Methods, systems, and apparatus, including computer programs encoded on a computer storage medium, for using a generative machine learning model to generate a data brief that characterizes the contents of a data store. In one aspect, a method comprises determining a user category of a user; generating a data brief that characterizes content from one or more data stores using a generative machine learning model by determining a prompt for the generative machine learning model based on the user category of the user, processing (i) the prompt and (ii) at least a subset of data stored in the data stores using the generative machine learning model to generate a model output in response the prompt, and including the generated model output in the data brief; and providing, to the user and by way of the user interface, a representation of the data brief generated using the generative machine learning model.

### CROSS-REFERENCE TO RELATED APPLICATION

This application claims the benefit under 35 U.S.C. § 119(e) of the filing date of U.S. Patent Application No. 63/743,188, filed on Jan. 8, 2025, and which is incorporated here by reference in its entirety.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that can use a generative machine learning model to generate a data brief that characterizes the contents of a data store.

Throughout this specification, a “data store” can refer to any system, device, or medium capable of storing data, including structured data and unstructured data. A data store may be implemented as a single physical or virtual memory or distributed across multiple physical or virtual memories, which may reside in one or more local devices, remote devices, or cloud-based systems.

A “data room” is a particular example of a data store. A data room can be used to store, manage, and share sensitive or confidential information while providing controlled access to authorized parties.

Throughout this specification, “structured data” can refer to data that is organized in a predefined format, e.g., using a schema to define relationships between data elements. Examples include tabular data stored in relational databases or spreadsheets, where information is arranged in rows and columns with defined fields.

Throughout this specification, “unstructured data” can refer to data that is not structured data. In particular, unstructured data lacks a predefined schema or organizational framework, such as tabular formats used in relational databases or spreadsheets. For instance, unstructured data may include documents containing free-form text, where the content is not organized into fixed fields or categories and may include natural language, variable formatting, or mixed content types.

According to a first aspect there is provided a method performed by one or more computers, comprising: determining a user category of a user, wherein the user category is selected from a predefined set of user categories; generating, using a generative machine learning model and based on data accessed from one or more data stores, a data brief that characterizes content from the data stores that is specific to the user category of the user, comprising: determining a prompt for the generative machine learning model that is based on the user category of the user, processing a model input that comprises: (i) the prompt based on the user category of the user, and (ii) at least a subset of data stored in the data stores, using the generative machine learning model to generate a model output that is responsive to the prompt, and including the model output generated by the generative machine learning model in the data brief; and providing, to the user and by way of the user interface, a representation of the data brief generated using the generative machine learning model.

In some implementations, the method further comprises: accessing the data stores to automatically extract data stored in the data stores that is predicted to be relevant to the prompt; and including the data extracted from the data stores that is predicted to be relevant to the prompt in the model input that is processed by the generative machine learning model to generate the model output that is included in the data brief.

In some implementations, determining the prompt for the generative machine learning model comprises: accessing a predefined prompt that is associated with the user category of the user.

In some implementations, determining the prompt for the generative machine learning model comprises: accessing data defining a decision graph that is associated with the user category of the user, wherein each output node of the decision graph is associated with a respective prompt; sequentially traversing a path from an input node of the decision graph to an output node of the decision graph, comprising, at each non-output node in the path: determining a classification of data stored in the data stores into a class from a predefined set of classes based on a classification criterion that is specific to the non-output node, identifying an edge that connects the non-output node to a child node of the non-output node and that is associated with the determined class of the data stored in the data stores, selecting the child node of the non-output node as a next node in the path; and identifying the prompt associated with the output node in the path as the prompt for the generative machine learning model.

In some implementations, determining the prompt for the generative machine learning model comprises: accessing data defining a decision graph that is associated with the user category of the user, wherein each output node of the decision graph is associated with a respective prompt; and determining a sequence of one or more prompts for the generative machine learning model over a sequence of one or more processing steps, comprising, at each processing step: sequentially traversing a path from an input node of the decision graph for the processing step to an output node of the decision graph for the processing step, comprising, at each non-output node in the path: performing the processing task associated with the non-output node using a subset of data stored in the data stores and selecting a child node of the non-output node as a next node in the path by applying a decision criteria for the non-output node based on a result of performing the processing task associated with the non-output node; and including a prompt associated with the output node in the path within the sequence of one or more prompts for the generative machine learning model.

In some implementations, for some or all of the non-output nodes in the path, performing the processing task associated with the non-output node using the subset of data stored in the data stores comprises: determining a classification of the subset of data stored in the data stores into a class from a predefined set of classes based on a classification criterion that is specific to the non-output node.

In some implementations, selecting the child node of the non-output node as the next node in the path comprises: identifying an edge that connects the non-output node to the child node of the non-output node and that is associated with the determined class of the subset of data stored in the data stores.

In some implementations, for some or all of the non-output nodes in the path, performing the processing task associated with the non-output node using the subset of data stored in the data stores comprises: obtaining the subset of data stored in the data stores by performing a query specified by the non-output node.

In some implementations, determining the sequence of one or more prompts for the generative machine learning model over the sequence of one or more processing steps comprises, at each processing step after the first processing step: determining the input node for the processing step based on a decision criteria of the output node for a preceding processing step.

In some implementations, for one or more of the processing steps after the first processing step, determining the input node for the processing step based on the decision criteria of the output node for the preceding processing step comprises: selecting a child node of the output node for the preceding processing step as the input node for the processing step based on the decision criteria of the output node for the preceding processing step.

In some implementations, for one or more of the processing steps after the first processing step, determining the input node for the processing step based on the decision criteria of the output node for the preceding processing step comprises: selecting a node from a different decision graph as the input node for the processing step based on the decision criteria of the output node for the preceding processing step.

In some implementations, for each non-output node in the path, determining the classification of data stored in the data stores based on the classification criterion that is specific to the non-output node comprises: determining the classification of data stored in the data stores based on the classification criterion that is specific to the non-output node using the generative machine learning model.

In some implementations, for each non-output node in the path, determining the classification of data stored in the data stores based on the classification criterion that is specific to the non-output node using the generative machine learning model comprises: processing a model input that comprises: (i) the classification criterion that is specific to the non-output node, and (ii) at least a subset of the data stored in the data stores, using the generative machine learning model to generate the classification of the data stored in the data stores.

In some implementations, the method further comprises: accessing the data stores to automatically extract data stored in the data stores that is predicted to be relevant to the classification of the non-output node; and including the data extracted from the data stores that is predicted to be relevant to the classification of the non-output node in the model input that is processed by the generative machine learning model to generate the classification of the data stored in the data stores.

In some implementations, the decision graph has a tree structure.

In some implementations, the decision graph comprises one or more cycles.

In some implementations, the method further comprises: determining, for each parameter in a set of parameters, a respective value for the parameter by querying the data stores using the generative machine learning model; processing the set of parameters using a prediction model to generate a prediction characterizing the data stored in the data stores; and including the prediction generated by the prediction model in the data brief.

In some implementations, the prediction model comprises a machine learning model.

In some implementations, the machine learning model comprises one or more of: a random forest model, or a neural network model, or a linear regression model, or a support vector machine model.

In some implementations, the prediction model has been trained on a set of training examples by a machine learning training technique.

In some implementations, each training example in the set of training examples comprises (i) a training input, and (ii) a target output, and training the prediction model comprises, for each training example, training the prediction model to reduce a discrepancy between: (i) a predicted output generated by processing the training input of the training example using the prediction model, and (ii) the target output of the training example.

In some implementations, the prediction model comprises a simulation model.

In some implementations, the prediction characterizing the data stored in the data stores comprises a probability distribution over a range of possible values of an entity characterized by the data stores.

In some implementations, the simulation model comprises a Monte Carlo model.

In some implementations, the prediction model comprises a plurality of distinct computational models that collectively form the prediction model.

In some implementations, for each parameter in the set of parameters, determining the value for the parameter by querying the data stores using the generative machine learning model comprises: processing a model input that comprises: (i) an instruction to determine the value of the parameter, and (ii) at least a subset of the data stored in the data stores, using the generative machine learning model to generate a model output that defines the value for the parameter.

In some implementations, the method further comprises: accessing the data stores to automatically extract data stored in the data stores that is predicted to be relevant to determining the value of the parameter; and including the data extracted from the data stores that is predicted to be relevant to determining the value of the parameter in the model input that is processed by the generative machine learning model to generate the model output that defines the value for the parameter.

In some implementations, the set of parameters comprises one or more risk factor parameters that each correspond to a respective risk affecting an outcome associated with the data stores.

In some implementations, each risk factor parameter has a value that defines a likelihood of the corresponding risk.

In some implementations, the method further comprises: generating an additional prompt for the generative machine learning model that is based at least in part on the prediction generated by the prediction model; processing a model input that comprises: (i) the additional prompt based on the prediction generated by the prediction model, and (ii) at least a subset of data stored in the data stores, using the generative machine learning model to generate a model output that is responsive to the additional prompt; and including the model output that is responsive to the additional prompt in the data brief.

In some implementations, processing the set of parameters using the prediction model to generate the prediction characterizing the data stored in the data stores comprises: determining an uncertainty measure that characterizes an uncertainty in the prediction generated by the prediction model, wherein generating the additional prompt for the generative machine learning model based at least in part on the prediction generated by the prediction model comprises: generating the additional prompt for the generative machine learning model based on both: (i) the prediction generated by the prediction model, and (ii) the uncertainty measure for the prediction generated by the prediction model.

In some implementations, the method further comprises: receiving, from the user, an additional user input that defines a prediction task to be performed based on the content of the data stores; and, in response to receiving the additional user input defining the prediction task: generating a set of training examples for training a prediction model to perform the prediction task by querying one or more training data stores using the generative machine learning model, dynamically training a prediction model on the set of training examples by a machine learning training technique to configure the prediction model to perform the prediction task, processing a model input derived from the data stores using the prediction model to generate a prediction output, and including the prediction output in the data brief.

In some implementations, for each training example in the set of training examples, generating the training example by querying a training data store using the generative machine learning model comprises: processing a model input that comprises: (i) an instruction to extract values of a set of input parameters and a target output, and (ii) at least a subset of data stored in the training data store, using the generative machine learning model to generate a model output that comprises the values of the set of input parameters and the target output; and generating a training example that includes: (a) the values of the set of input parameters as a training input, and (b) the value of the target output as a prediction target to be generated by the prediction model by processing the training input.

In some implementations, the additional user input that defines the prediction task includes a specification of the set of input parameters.

In some implementations, the method further comprises, prior to generating the set of training examples for training the prediction model, determining the set of input parameters for the prediction model using the generative machine learning model, comprising: processing a model input that comprises: (i) an instruction to identify a set of input parameters that are relevant to performing the prediction task, and (ii) at least a subset of data stored in the data stores, using the generative machine learning model to generate a model output that identifies the set of input parameters.

In some implementations, the method further comprises generating the model input that is processed by the prediction model, comprising: processing a model input that comprises: (i) an instruction to extract values of a set of input parameters to the prediction model, and (ii) at least a subset of data stored in the data stores, using the generative machine learning model to generate a model output that defines the values of the set of input parameters, wherein the values of the set of input parameters collectively define the model input that is processed by the prediction model.

In some implementations, the generative machine learning model comprises a generative neural network.

In some implementations, the generative machine learning model has been trained to perform a language modeling task.

In some implementations, the generative machine learning model is an autoregressive generative machine learning model.

In some implementations, processing the model input that comprises: (i) the prompt based on the user category of the user, and (ii) at least the subset of data stored in the data stores, using the generative machine learning model to generate the model output that is responsive to the prompt comprises sequentially generating a sequence of output tokens that collectively define the model output, comprising, for each of a plurality of positions in the sequence of output tokens: processing the prompt based on the user category of the user, at least the subset of data stored in the data stores, and output tokens generated for any preceding position that precedes the position in the sequence of output tokens, using the generative machine learning model to generate a score distribution over a set of possible tokens; and selecting a token to occupy the position in the sequence of output tokens based on the score distribution over the set of possible tokens.

In some implementations, for each of the plurality of positions in the sequence of output tokens, selecting the token to occupy the position in the sequence of output tokens based on the score distribution over the set of possible tokens comprises: selecting a token having a highest score under the score distribution as the token to occupy the position in the sequence of output tokens.

In some implementations, the data stores comprise data relevant to a drug.

In some implementations, the data brief characterizes one or more of: a mechanism of action of the drug; a target of the drug; clinical validation of the drug; a target disease indication; or existence of backup series.

In some implementations, the data brief characterizes a net present value of the drug.

In some implementations, the data brief comprises a plurality of risk scores characterizing risks associated with the drug.

In some implementations, the data brief comprises respective risk scores corresponding to each of one or more of: in vitro pharmacology; safety and toxicology; biomarkers; clinical trials; or regulatory issues.

In some implementations, the data stores comprise at least one million characters of text.

In some implementations, the method further comprises, for each of a plurality of parts of the model output generated by the generative machine learning model by processing the model input that comprises: (i) the prompt based on the user category of the user, and (ii) at least the subset of data stored in the data stores: identifying a part of the data stored in the data stores that supports the part of the model output; and including a reference to the part of the data stored in the data stores that supports the part of the model output in the data brief.

In some implementations, generating the data brief that characterizes content from the data stores that is specific to the user category of the user comprises: processing the model output generated by the generative machine learning model to: (i) generate an auxiliary prompt, and (ii) identify one or more auxiliary data stores that include content relevant to the auxiliary prompt; processing an auxiliary model input that comprises: (i) the auxiliary prompt, and (ii) at least a subset of data stored in the auxiliary data stores, using the generative machine learning model to generate an auxiliary model output; and including the auxiliary model output generated by the generative machine learning model in the data brief.

In some implementations, the method further comprises: receiving user feedback on the data brief by way of the user interface; and updating current values of: (i) a set of machine learning model parameters of the generative machine learning model, or (ii) one or more parameters of a prediction model that is used to generate the data brief, based on the user feedback.

In some implementations, the user feedback comprises a rating for the data brief and updating current values of: (i) a set of machine learning model parameters of the generative machine learning model, or (ii) one or more parameters of a prediction model that is used to generate the data brief, based on the user feedback comprises: updating the current values of the set of machine learning model parameters of the generative machine learning model using a reinforcement learning with human feedback (RLHF) technique.

In some implementations, the user feedback comprises an alternative value for a parameter of the prediction model and updating current values of: (i) a set of machine learning model parameters of the generative machine learning model, or (ii) one or more parameters of a prediction model that is used to generate the data brief, based on the user feedback comprises: re-running the prediction model using the alternative value for the parameter of the prediction model.

In some implementations, the data stores comprise both unstructured data and structured data.

Particular embodiments of the subject matter described in this specification can be implemented so as to realize one or more of the following advantages.

Processing and using large quantities of information stored in data stores such as data rooms presents significant challenges for conventional data processing systems due to the volume, complexity, and heterogeneity of the stored data. For example, in the case of a data room for a pharmaceutical drug, the data room may contain diverse types of information, including clinical trial data, scientific data, preclinical study results, manufacturing protocols, regulatory filings, and intellectual property documentation. The data stored in a data store may be distributed across multiple formats, including text, images, and structured databases, and may be interdependent or context-specific. Data stores also typically store large volumes of data, e.g., on the order of thousands or tens of thousands of pages of documents, millions or tens of millions of characters of text, and so on. Furthermore, interpreting such data often necessitates specialized expertise in various domains (such as pharmacology, toxicology, statistics, and so forth), making it difficult to extract actionable insights. These challenges are compounded by the need to synthesize and integrate information to support decision-making.

The system described in this specification can use a generative machine learning model to generate a data brief that characterizes the contents of one or more data stores. For instance, when applied to a data room for a pharmaceutical drug, the data brief can include content related to: the scientific and clinical viability of the drug (e.g., characterizing the mechanism of action of the drug; and safety, efficacy, and tolerability data); production processes for the drug (e.g., manufacturing procedures and validation reports); safety and risk assessments (e.g., adverse events and outcomes data); and so forth.

In addition to summarizing and integrating information from across the data stores, the system can leverage the generative machine learning model to automatically extract parameter sets from the data stores which are then fed into computational models that perform predictive modeling. The system can include the results of the predictive modeling in the data brief, and can also use the results of the predictive modeling to generate new queries to extract additional insights and content from the data stores for inclusion in the data brief. For instance, when applied to a data room for a pharmaceutical drug, the system can use the generative machine learning model to automatically search the data room to identify risk factors that may influence the scientific or clinical feasibility of the drug, and then perform computational modeling (based at least in part on these risk factors), e.g., to predict a likelihood of the drug successfully completing clinical trials.

The system includes innovative features that provide novel technical solutions to a variety of technical problems that arise when using a generative machine learning model to generate data briefs characterizing the contents of data stores, as will be described in more detail next.

One issue that arises when querying data stores using a generative machine learning model is the construction of a prompt that is provided as part of a model input to the generative machine learning model, e.g., along with data that is extracted from the data stores. The prompt may include instructions to extract data from the data stores for inclusion in the data brief, or to synthesize, integrate, and summarize information from various parts of the data stores, or to make predictions based on the content of the data stores, and so forth. An approach to defining a prompt is to use a large, generic prompt that includes general instructions to extract and synthesize large quantities of information from the data stores, and to generate an array of predictions based on the contents of the data stores. However, this approach is computationally inefficient, as it requires providing a lengthy model input to the generative machine learning model that includes a large prompt and large quantities of data extracted from the data stores in order to provide material for answering queries included in the prompt. The computational complexity and burden of processing the model input using the machine learning model can rapidly increase with the size of the model input. For instance, many generative machine learning models (e.g., language models, such as large language models, vision-language models, etc.) rely on self-attention by performing self-attention operations that have complexities and computational costs that can increase quadratically with the quantity of input data. The computational costs of generating a data brief characterizing the contents of a data store can therefore scale quadratically with, e.g., the lengths of input prompts, the amount of input data extracted from the data stores and so on processed by the generative machine learning model. Conventional methods that involve using generative models to process lengthy model inputs that include large prompts and large quantities of data extracted from the data stores therefore incur significant computational costs due to the quadratic scaling of the complexity of self-attention operations with model input sizes.

To address this issue, the system can use a decision graph to construct a prompt that is tailored to the particular data stores that are the subject of the data brief. More specifically, the system can traverse the decision graph, tracing a path starting from an “input” node until an “output” node is reached. Each output node is associated with a particular prompt, and the system can then select the prompt associated with the output node in the path as part of the model input to the provided to the generative machine learning model. At each non-output node in the path, the system can evaluate a classification criterion associated with the node based on the contents of the data stores, and select a child node of the non-output node as the next node in the path based on the result of the classification. For instance, in the case where the data stores include a data room for a drug, one node may be associated with a classification criterion based on whether the drug is: a biologic drug, or a small molecule drug, or a peptide drug, or a nucleotide-based drug, or an antibody-based drug, or a vaccine, and so forth. Each output node is associated with a prompt that is specifically tailored to be targeted and focused for data stores that satisfy the sequence of classification criteria associated with the path through the decision graph that terminates at the output node.

The system can therefore reduce consumption of computational resources by processing shorter, targeted prompts that are identified by traversing a decision graph (as outlined above) as opposed to processing lengthy, generic prompts. First, a targeted prompt obtained using the decision graph can be shorter than a generic prompt, e.g., because the targeted prompt can exclude many generic queries that may be irrelevant to the data stores at issue. Second, as part of augmenting the model input to include data extracted from the data stores (i.e., in addition to the prompt), the system can extract smaller quantities of data that are specifically relevant to a targeted prompt obtained from the decision graph, instead of larger quantities of data that are relevant to a lengthy, generic prompt.

Another issue that arises when querying data stores using a generative machine learning model is the limitations of the generative machine learning model itself when performing computational prediction tasks. For instance, the generative machine learning model may have been trained on a large corpus of training data to perform a language modeling task, e.g., a next character prediction task, that enables the generative machine learning model to effectively identify, extract, and synthesize data from data stores. However, the generative machine learning model may be poorly equipped to perform specialized computational prediction tasks, e.g., predicting the likelihood that a drug will successfully complete a particular clinical trial based on a large set of numerical parameters characterizing various biochemical and pharmacological properties of the drug, inclusion criteria for the clinical trial, and so forth. One approach to addressing this issue is to finetune the generative machine learning model to perform specialized computational prediction tasks. However, performing such finetuning is computationally expensive (as it requires training a large generative machine learning model, possibly with millions or billions of parameters) and may diminish the overall performance of the generative machine learning model, e.g., due to phenomena such as catastrophic forgetting.

To address this issue while maintaining computational feasibility and efficiency, the system can use the generative machine learning model to extract a set of parameters relevant to making a prediction of interest from the data stores. The system can then process these parameters using a separate computational model, e.g., a machine learning model or a simulation model (e.g., a Monte Carlo simulation model), that is specialized for performing this particular prediction task. The separate computational model can be “lightweight” computational model, e.g., having significantly fewer parameters than the generative machine learning model, operating with low latency and incurring a low computational footprint, because the computational model is required to perform a relatively narrow computational prediction task. The system can use predictions generated by the prediction models, e.g., for parametrizing new prompts for the generative machine learning model, or to augment the data brief, or both.

Another issue that arises when querying data stores using a generative machine learning model that can leverage one or more separate prediction models (as outlined above) is that the number of prediction models that can be trained and maintained by the system is limited, e.g., by memory and computational requirements. In particular, the system may be unable to train and store a respective prediction model for every computational prediction task that may be of interest to a user when generating a data brief. To address this issue, in response to receiving a request from a user to perform a prediction task that is outside the scope of any existing computational models that the system currently maintains, the system can dynamically train a prediction model to perform the prediction task. In particular, the system can use the generative machine learning model to automatically extract training data from one or more “training” data stores, and then train a prediction model on the newly generated training data. In this manner, the system can reduce consumption of computational resources, e.g., memory and computing power, as compared to an approach that requires training and storing large numbers (e.g., hundreds or thousands) of prediction models, some of which may be rarely or never used.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example data brief system.

FIG. 2 is a flow diagram of an example process for automatically generating a data brief characterizing content from one or more data stores for a user.

FIG. 3 illustrates example decision graphs for generating a data brief.

FIG. 4 illustrates determining a prompt for a generative machine learning model using a decision graph as part of a processing step of generating a data brief.

FIG. 5 is a flow diagram of an example process of using a decision graph to determine a prompt for a generative machine learning model.

FIG. 6 is a flow diagram of an example process of performing a prediction task as part of generating a data brief.

FIG. 7 is a flow diagram of an example process of training a specialized prediction model to perform a prediction task for generating a data brief.

FIG. 8 illustrates an example of a first user interface that a data brief system can present to a user.

FIG. 9 illustrates an example representation of a prediction generated by a specialized prediction model of a data brief system.

FIG. 10 illustrates an example of a second user interface that a data brief system can present a user.

FIG. 11 illustrates an example of a third user interface that a data brief system can present to a user.

FIG. 12 illustrates an example of a data flow that can be implemented by a data brief system as described in this specification.

FIG. 13A illustrates a first portion of a software stack that can be used to implement a data brief system as described in this specification.

FIG. 13B illustrates a second portion of a software stack that can be used to implement a data brief system as described in this specification.

FIG. 13C illustrates a third portion of a software stack that can be used to implement a data brief system as described in this specification.

Like reference numbers and designations in the various drawings indicate like elements.

### DETAILED DESCRIPTION

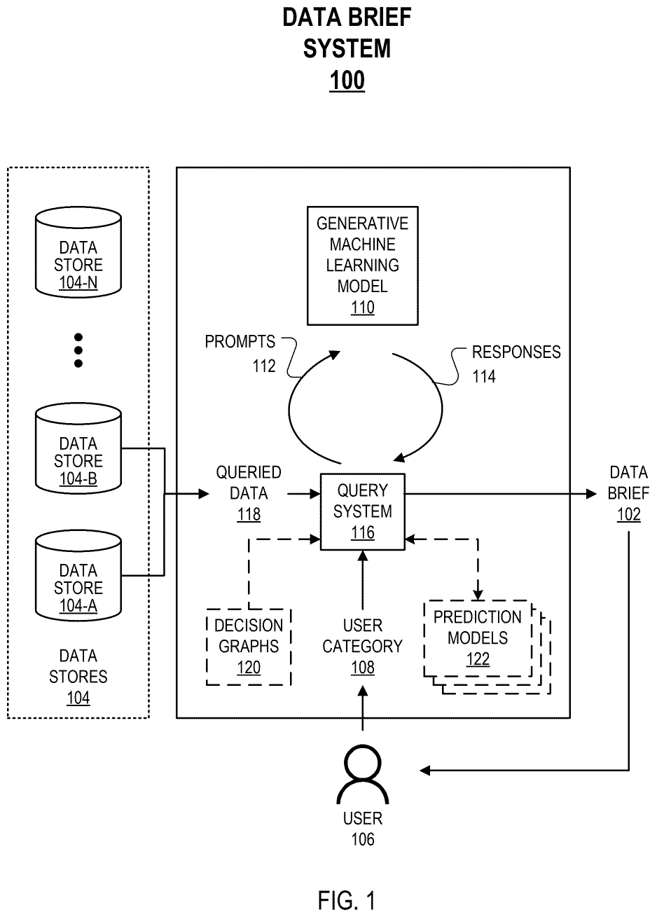

FIG. 1 shows an example data brief system 100. The data brief system 100 is an example of a system implemented as computer programs on one or more computers in one or more locations in which the systems, components, and techniques described below are implemented.

The data brief system 100 can automatically generate a data brief 102 that characterizes contents of one or more data stores 104 for a user 106. The data brief 102 can include any of a variety of data characterizing relevant contents of the data stores 104 for the user 106, such as natural language summaries of relevant contents of the data stores 104, prediction results generated by processing relevant contents of the data stores 104, visualizations (e.g., plots, images, videos, tables, etc.) of relevant contents of the data stores 104, and so on.

In general, the contents of the data stores 104 can include any of a variety of data, such as text data, numerical data, image data, audio data, video data, tabular data, and so on. For example, the contents of the data stores 104 can include structured data organized following predefined formats (e.g., following schemas that define relationships between data elements of the structured data). As a further example, the contents of the data stores 104 can include tabular data stored in, e.g., relational databases, spreadsheets, file systems, and so on. As another example, the contents of the data stores 104 can include unstructured data (e.g., data that is stored without a particular schema or organizational format). For example, the contents of the data stores 104 can include unstructured collections of documents that include, e.g., free-form text, natural language text, variable formatting, mixed content types, and so on.

The data stores 104 can be implemented in any appropriate manner. For example, each of the data stores 104 can be implemented as a single physical or virtual memory or can be distributed across multiple physical or virtual memories. The physical or virtual memories for the data stores 104 can be implemented using any appropriate combination of local, remote, and/or cloud-based devices.

Some or all of the data stores 104 can be data rooms that store sensitive or confidential information for particular, e.g., projects, programs, cases, and so on that can be accessed only by associated sets of users. The data brief system 100 can determine which of the data stores 104 the user 106 is authorized to access and can generate the data brief 102 for the user 106 based solely on the contents of the data stores 104 that the user 106 is authorized to access.

In some cases, the user 106 can select (e.g., by means of a user interface of the data brief system 100) particular data stores 104 for the data brief system 100 to use when generating the data brief 102. For example, when the user 106 is authorized to access multiple different data stores 104, the user 106 can select a particular data store as the subject of the data brief 102 and the system 100 can then generate the data brief 102 to summarize the contents of the selected data store. As another example, when the user 106 is authorized to access multiple different data stores 104, the user 106 can select one or more data stores 104 that include contents that the system 100 can reference when generating the data brief 102. As a further example, in some implementations, the user 106 can select a particular data store as the subject of the data brief 102 and one or more reference data stores for the data brief 102 and the system 100 can then generate the data brief 102 to summarize the contents of the subject data store in relation to the contents of the one or more reference data stores.

Each of the data stores 104 can include a large volume of complex and heterogeneous data. For example, each of the data stores 104 can include on the order of thousands or tens of thousands of pages of documentation for a project or program. As another example, the data stores 104 can include large quantities of text (e.g., at least one million characters of text). Often, only a subset of the content of a data store will be relevant to the user 106. To generate the data brief 102 to characterize contents of the data stores 104 that are relevant to the user 106, the data brief system 100 can identify and process the contents of the data stores 104 that are relevant to the user 106 as part of generating the data brief 102 for the user 106.

In particular, the data brief system 100 can determine a user category 108 of the user 106, which the system 100 can use to determine which contents of the data stores 104 are relevant to the user 106. The user category 108 for the user 106 can be selected from a predefined set of user categories. The system 100 can associate individual data items (e.g., individual documents, images, databases, spreadsheets, tables, audio files, video files, etc.) can be associated with particular user categories within the predefined set of user categories. When generating the data brief 102 for the user 106, the system 100 can retrieve and process the contents of the data stores 104 that are associated with the determined user category 108 for the user 106, enabling the system 100 to generate the data brief 102 based on the contents of the data stores 104 that are relevant for the user 106.

In some implementations, the data brief system 100 can determine particular processing steps to perform as part of generating the data brief 102 based on the user category 108 for the user 106. Therefore, in some implementations, the system 100 can perform different processing steps as part of generating data briefs for different users in addition to processing different contents of the data stores 104 for the different users. Example methods by which the system 100 can determine processing steps to perform based on the user category 108 of the user 106 are described in more detail below.

The data brief system 100 can determine the user category 108 for the user 106 by any appropriate method. For example, in some implementations, the user 106 can select the user category 108 from the predefined set of user categories by means of a user interface (UI) of the system 100. As another example, in some implementations, the system 100 can process data associated with the user 106, such as a user ID, user account data, and so on, to determine the user category 108 of the user 106.

The data brief system 100 can use a generative machine learning model 110 to process the relevant contents from the data stores 104 (e.g., the contents from the data stores 104 associated with the user category 108 of the user 106) to generate the data brief 102 for the user 106. In particular, the system 100 can generate the data brief 102 over a sequence of one or more processing steps by processing respective prompts 112 for the processing steps using the generative machine learning model 110 to generate respective responses 114 for the processing steps. The system 100 can generate the prompt for each processing step to include data characterizing some or all of the relevant contents of the data stores 104 for generating the data brief 102. After processing the prompt for each processing step using the generative machine learning model 110, the system 100 can include some or all of the resulting response for the processing step within the data brief 102. In some implementations, for some or all of the processing steps, the system 100 can generate the prompt for the processing step to include data generated by the generative machine learning model 110 during preceding processing steps. For example, in some implementations, the system 100 can generate the prompt for a processing step to include some or all of the responses generated by the generative machine learning model 110 during previous processing steps.

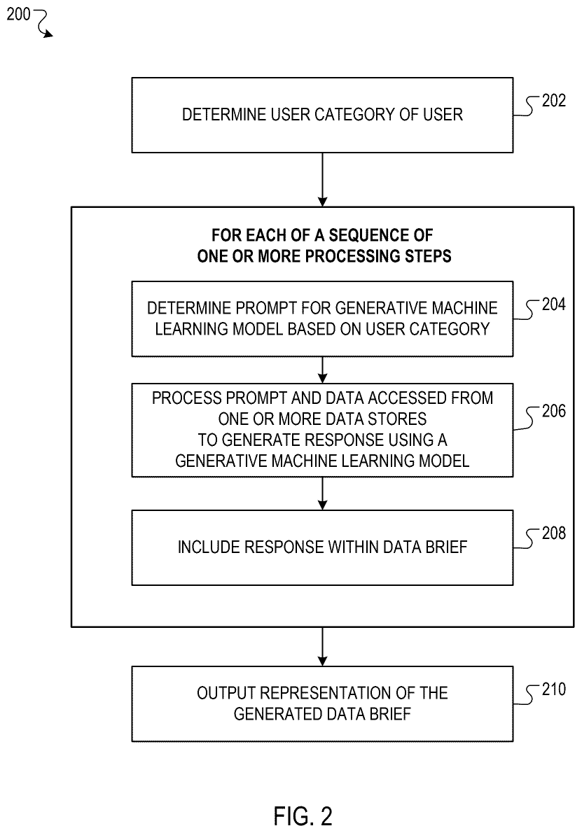

An example process by which the data brief system 100 can generate the data brief 102 for the user 106 using the generative machine learning model 110 is described in more detail below with reference to FIG. 2.

By determining which contents of the data stores 104 are relevant for the user 106, the data brief system 100 can generate targeted prompts 112 for the generative machine learning model 110 that are specific to generating the data brief 102 for the user 106. As the data stores 104 often include data that is irrelevant to generating the data brief 102 for the user 106, generating and processing such targeted prompts 112 can reduce the computational costs (e.g., processing time, memory consumption, etc.) of generating the data brief 102 for the user, e.g., as compared processing the entire contents of a data store using the generative machine learning model 110 to generate the data brief 102 for the user 106.

In general, the generative machine learning model 110 can be configured to generate model outputs by stochastically sampling the model outputs from a probability distribution over a space of possible outputs determined by model parameters of the generative machine learning model 110. The generative machine learning model 110 can be configured to conditionally generate a model output as conditioned on a model input to the generative machine learning model 110 by sampling the model outputs from a conditional probability distribution of model outputs (as conditioned on the model input) that is determined by processing the model input in accordance with the model parameters of the generative machine learning model 110.

The generative machine learning model 110 can be configured to generate a sequence of multiple model outputs by sampling the multiple model outputs from a joint probability distribution for the multiple model outputs determined by model parameters of the generative machine learning model 110. In some cases, the generative machine learning model 110 can be an autoregressive model that is configured to autoregressively generate a sequence of multiple model outputs by sequentially generating each of the multiple model outputs, e.g., as conditioned previously generated model outputs and the model input.

The generative machine learning model 110 can have any appropriate generative machine learning architecture for processing model inputs representing the prompts 112 and generating model outputs representing the responses 114 for the processing steps of generating the data brief 102. In particular, the generative machine learning model 100 can include any of a variety of processing layers (e.g., feed-forward layers, recurrent layers, convolutional layers, attention layers, etc.) in any appropriate combination for processing model inputs representing the prompts 112 and generating model outputs representing the responses 114 for the processing steps of generating the data brief 102. As a particular example, the generative machine learning model 110 can be include a plurality of attention layers (e.g., self-attention layers, cross-attention layers, etc.) that can each perform respective attention operations (e.g., self-attention operations, cross-attention operations, etc.) as part of processing the model inputs representing the prompts 112 to generate the model outputs representing the responses 114. As a further example, the generative machine learning model 110 can be a Transformer neural network that includes a plurality of attention layers configured to process the model inputs representing the prompts 112 to generate the model outputs representing the responses 114. Some examples of generative machine learning architectures include, e.g., generative adversarial networks (GANs), variational auto-encoders (VAEs), normalizing flows, diffusion models, autoregressive models, and so on.

The generative machine learning model 110 can be a token processing neural network that is configured to process input token sequences representing the prompts 112 for the processing steps of generating the data brief 102. In particular, the generative machine learning model 110 can be a language model (e.g., a large language model (LLM), a vision-language model (VLM), etc.) that can process input token sequences representing the prompts 112 to generate output token sequences representing the responses 114 for the processing steps of generating the data brief 102.

The input and output token sequences can include text tokens that represent respective text, e.g., words, wordpieces or characters, in a natural or computer code language. In particular, the input and output token sequences can include sequences of text tokens as selected from a vocabulary of text tokens (e.g. that each represent words, wordpieces or characters in a natural or computer code language) for the generative machine learning model 110. As part of generating the input token sequences for the generative machine learning model 100, the data brief system 100 can process input text (e.g., natural language text for the prompts 112, etc.) using a text encoder (e.g., a text tokenizer) generate sequences of text tokens representing the prompts 112 using tokens from the vocabulary of text tokens. The text tokenizer can tokenize input text using any appropriate encoding scheme, e.g., byte pair encoding (BPE), Wordpiece tokenization, and so on.

In some implementations, the generative machine learning model 110 can be a multi-modal language model, such as a vision-language model, that is configured to process and/or generate token sequences that include tokens representing non-text data modalities. For example, the token sequences processed and/or generated by the generative machine learning model 110 can include image tokens representing image data, video tokens representing video data, audio tokens representing audio data, and so on.

As part of generating the input token sequences, the data brief system 100 can process input data for a non-text data modality using an encoder (e.g., a tokenizer) for the non-text data modality to generate a sequence of tokens representing the input data for the non-text data modality. For example, the generative machine learning system can include an image encoder configured to tokenize input image data, a video encoder configured to tokenize input video data, an audio encoder configured to tokenize input audio data, and so on. Such encoders for the non-text data modalities can tokenize input data for the non-text data modalities any appropriate encoding schemes, e.g., using a transformer neural network (e.g., a vision transformer (ViT) neural network), using vector quantization, using block encoding, using patch encoding, and so on.

In general, the generative machine learning model 110 can be trained to optimize a maximum-likelihood objective to process example input prompts to generate target responses using a large training dataset that includes, e.g., example text in one or more natural languages, example computer code in one or more computer code languages, example images and so on. In some cases, the generative machine learning model 110 can be trained in multiple training stages including, e.g., a supervised fine-tuning stage, a reinforcement learning stage (e.g., using reinforcement learning from human or other feedback), a preference learning stage, an instruction tuning stage, and so on.

The data brief system 100 can include a query system 116 that is configured to generate the prompts 112 for the generative machine learning model 110 and process the resulting responses 114 from the generative machine learning model 110 to generate the data brief 102 for the user 106. At each processing step of generating the data brief 102, the query system 116 can query (e.g., access) the data stores 104 to identify and automatically extract contents of the data stores 104 that are relevant to generating the data brief 102 for the user 106. The query system 116 can generate the prompts 112 for the generative machine learning model 110 using the queried data 118 from the data stores 104. For example, the query system 116 can include some or all of the queried data 118 within the prompts 112 for the generative machine learning model 110. As another example, in some implementations, the query system 116 can select or generate text instructions to include within the prompts 112 for the generative machine learning model 110 based on the queried data 118 from the data stores 104.

The query system 116 can generate the prompts 112 to the generative machine learning model 110 and process the responses 114 from the generative machine learning model 110 by any of a variety of methods. For example, in some implementations, the data brief system 100 can store data specifying a pre-defined sequence of processing steps that the query system 116 can perform to generate the data brief 102. Following the pre-defined sequence of processing steps, the query system 116 can execute pre-defined queries of the data stores 104 to obtain the queried data 118, provide pre-defined prompts 112 to the generative machine learning model 110 following, and can utilize a pre-defined output process to determine the portions of the resulting responses 114 to include within the data brief 102.

As another example, in some implementations, the data brief system 100 can be a language model agent system that includes one or more language models (e.g., LLMs, VLMs, multi-modal language models, etc.) that are each configured to perform respective tasks as part of generating the data brief 102 for the user 106. Each language model agent of the system 100 can be configured to interact with other models of the system 100 (including other language model agents), e.g., by providing model inputs to the models and by processing model outputs generated by the other models. For example, the query system 116 can be a planning language model agent of the system 100 that is configured to plan and coordinate performing the processing steps to generate the data brief 102 for the user 106. When the query system 116 is a planning language model agent of the system 100, the data brief system 100 can store data characterizing high-level descriptions of the processing steps for generating the data brief 102, such as natural language text descriptions of the processing steps, which the query system 116 can process and interpret to generate the prompts 112 for the generative machine learning model 110.

In some implementations, the generative machine learning model 110 can be a language model agent of the data brief system 100. When the generative machine learning model 110 is a language model agent of the system 100, the prompts 112 can include high-level descriptions (e.g., natural language text descriptions) of particular tasks for the model 110 to perform as part of generating the data brief 102.

When the data brief system 100 is a language model agent system, each language model agent of the system can be configured to interact with various tools and/or programs. For example, a language model agent of the system can provide input data for processing by an external tool or program (e.g., by means of an API of the external tool or program) and can receive resulting output data from the external tool or program (e.g., by means of the API of the external tool or program). As a further example, the query system 116 and/or the generative machine learning model 110 can, e.g., query and retrieve contents of the data stores 104 using an API of the data stores 104, interact with other models of the system 100 using an API of the system 100, interact with external systems using APIs of the external systems, and so on.

In some implementations, the data brief system 100 can store one or more decision graphs 120 that the query system 116 can use to construct the prompts 112 for the generative machine learning model 110. Each of the decision graphs 120 can include graph nodes that characterize instructions to perform particular tasks as part of generating the data brief 102. Each graph node of a decision graph can characterize instructions, e.g., to query particular data from the data stores 104, to summarize or classify queried data 118 from the data stores 104, to perform a particular prediction task based on the queried data 118 from the data stores 104, to process the queried data 118 from the data stores 104 to generate a prompt for the generative machine learning model 110, and so on. In some implementations, the decision graphs 120 can include data specifying predefined instructions for performing tasks as part of generating the data brief 102. A graph node of the decision graphs 120 can include data specifying operations for performing tasks associated with the graph node, such as pre-defined queries to perform to obtain data from the data stores 104, pre-defined computations or predictions to perform using the queried data 118, pre-defined prompts to provide to the generative machine learning model 110, pre-defined templates for generating prompts to provide to the generative machine learning model 110, pre-defined operations to perform to include data generated by the generative machine learning model 110 within the data brief 102, and so on.

In some implementations (e.g., when the data brief system 100 is a language model agent system), the decision graphs 120 can include high-level descriptions (e.g., natural language text descriptions) of tasks to perform as part of generating the data brief 102. A graph node of the decision graphs 120 can include high-level descriptions (e.g., natural language text descriptions) of, e.g., data to query from the data stores 104, computations or predictions to perform using the queried data 118, formats and/or contents of prompts for the generative machine learning model 110, how data generated by the generative machine learning model 110 should be included within the data brief 102, and so on.

The data brief system 100 can generate the data brief 102 using a decision graph by performing the tasks associated with a connected sequence (e.g., path) of graph nodes within the decision graph. After performing the tasks associated with a graph node, the data brief system 100 can use the results from performing the tasks associated with the graph node to select a next node for the connected sequence of graph nodes for generating the data brief 102.

In some implementations, the data brief system 100 can store multiple different decision graphs 120 and can select a particular decision graph to use to generate the data brief 102. For example, the data brief system 100 can include respective decision graphs associated with each of the set of user categories and can select the particular decision graph for generating the data brief 102 based on the user category 108 of the user 106. As another example, the system 100 can include decision graphs associated with classes or groups of data stores 104 and can select the particular decision graph for generating the data brief 102 based on which data stores 104 are selected as the subject or references for the data brief 102. As another example, in some implementations, the user 106 can select the particular decision graph for generating the data brief 102 from a plurality of decision graphs, e.g., by means of the user interface of the system 100.

The data brief system 100 can therefore determine the processing steps to perform to generate the data brief 102 by performing tasks associated with a connected path of graph nodes through a decision graph for generating the data brief 102. Using the decision graphs 120 to generate the data brief 102 can enable the system 100 to dynamically determine processing tasks to perform to generate the data brief 102 based on the specific contents of the data store 104 that are relevant to the user 106 and can further reduce the computational costs of generating the data brief 102. For example, the targeted prompts 112 obtained using the decision graphs 120 can be shorter than a generic prompt, as the targeted prompt can exclude generic queries for the data stores 104 that would be irrelevant to generating the data brief 102 for the user 106. Additionally, when generating the targeted prompts 112 using the decision graphs 120, the system 100 can query a smaller amount of data from the data stores 104 that is specifically relevant to generating the data brief 102 for the user 106, e.g., as compared to the instead of the larger quantities of data that are required for lengthier, more generic prompts.

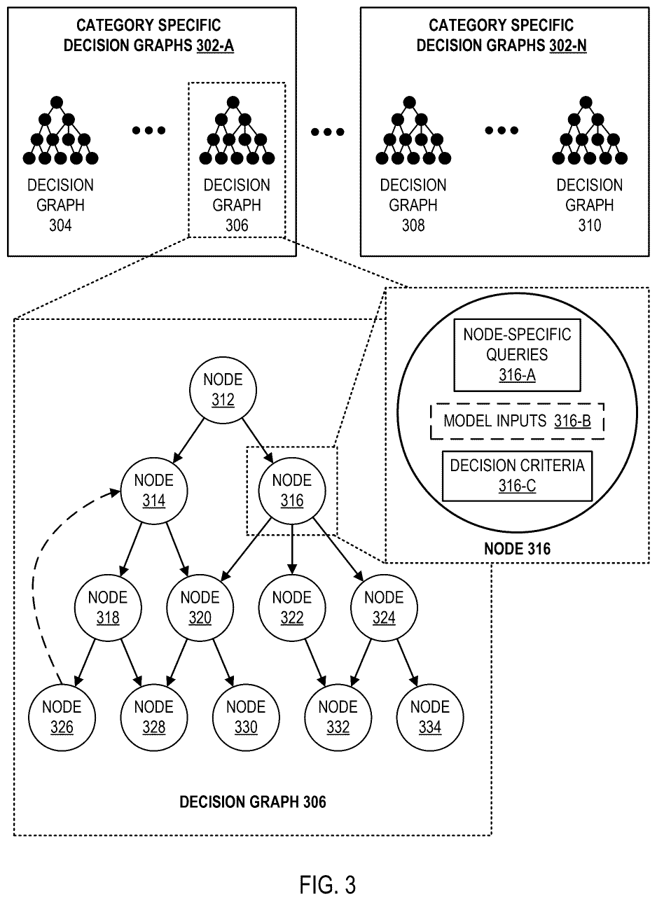

Example decision graphs 120 and example methods by which the data brief system 100 can use the decision graphs 120 to generate the data brief 102 are described in more detail below with reference to FIGS. 3-5.

In some implementations, the data brief system 100 can include one or more additional prediction models 122 that are configured to perform respective prediction tasks based on contents of the data stores 104 as part of generating the data brief 102. While generating the data brief 102, the system 100 can generate model inputs for the prediction models 122 using queried data 118 from the data stores 104, which the system 100 can then process using the prediction models 122 to generate predictions that the system 100 can use as part of generating the data brief 102.

The data brief system 100 can use the predictions from the prediction models 122 in various ways as part of generating the data brief 102. For example, in some cases, the system 100 can include one or more predictions generated using the prediction models 122 within the data brief 102. As another example, in some cases, the system 100 can evaluate criteria based on one or more output predictions generated using the prediction models 122 to determine particular tasks to perform as part of generating the data brief 102.

When the data brief system 100 uses the decision graphs 120 to generate the data brief 102, the decision graphs 120 can include one or more graph nodes that characterize instructions to perform prediction tasks using the prediction models 122. For example, a graph node of a decision graph can characterize instructions to perform a particular prediction task using one of the prediction models 122, e.g., by characterizing instructions to execute a particular query to perform of the data stores 104 to obtain model inputs for the particular prediction task, by characterizing instructions to perform one or more additional tasks to perform using the resulting outputs for the particular prediction task, and so on.

When the data brief system 100 is a language model agent system, the language model agents of the system 100 can interact with the prediction models 122 as part of performing their respective tasks to generate the data brief 102. For example, the query system 116 and/or the generative machine learning model 110 can provide data for processing by one or more of the prediction models 122 and can utilize the resulting predictions from the one or more of the prediction models 122 as part of performing a task for generating the data brief 102.

In general, the prediction models 122 can be configured to perform any of a variety of prediction tasks, e.g., classification tasks, regression tasks, forecasting tasks, sequence processing tasks, and so on. Each of the prediction models 122 can be configured to perform a respective prediction task by processing model inputs for the prediction task to generate prediction outputs for the prediction task. The prediction models 122 can include any combination of, e.g., simulation models, statistical models, Monte Carlo models, machine learning models, and so on. The prediction models 122 can include any of a variety of machine learning models, e.g., regression models, decision tree models, random forest models, support vector machine models, neural network models, and so on. When a prediction model is a neural network configured to perform a particular prediction task, the prediction model can include any of a variety of processing layers (e.g., feed-forward layers, convolutional layers, recurrent layers, attention layers, and so on) in any appropriate combination for processing model inputs for the particular prediction task to generate prediction outputs for the particular prediction task.

The prediction models 122 can be “lightweight” models that are specialized to perform their respective prediction tasks. In particular, the prediction models 122 can each have significantly fewer parameters than, e.g., the generative machine learning model 110. Utilizing such “lightweight”, specialized prediction models 122 can enable the data brief system 100 to more efficiently and more accurately perform prediction tasks as part of generating the data brief 102, e.g., as compared to performing the prediction tasks using a larger, more generalized model, such as the generative machine learning model 110.

In some implementations, the data brief system 100 can use the contents of the data stores 104 to determine parameters for the prediction models 122. For example, in some cases, the data stores 104 can include data specifying parameters for a prediction model and the system 100 can query the data stores 104 to obtain the parameters for the prediction model. In some implementations, the data stores 104 can include training data for a prediction model and the system 100 can train the prediction model using training data for the prediction model as queried from the data stores 104. Therefore, rather than storing and maintaining large numbers (e.g., hundreds or thousands) of separate prediction models 122 (some of which may be rarely or never used), the data brief system 120 can use the contents of the data stores 104 to dynamically initialize and/or train prediction models 122 as needed when generating the data brief 102.

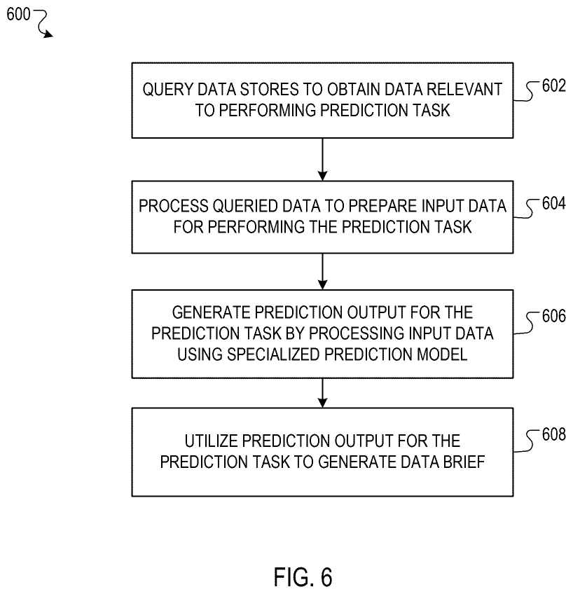

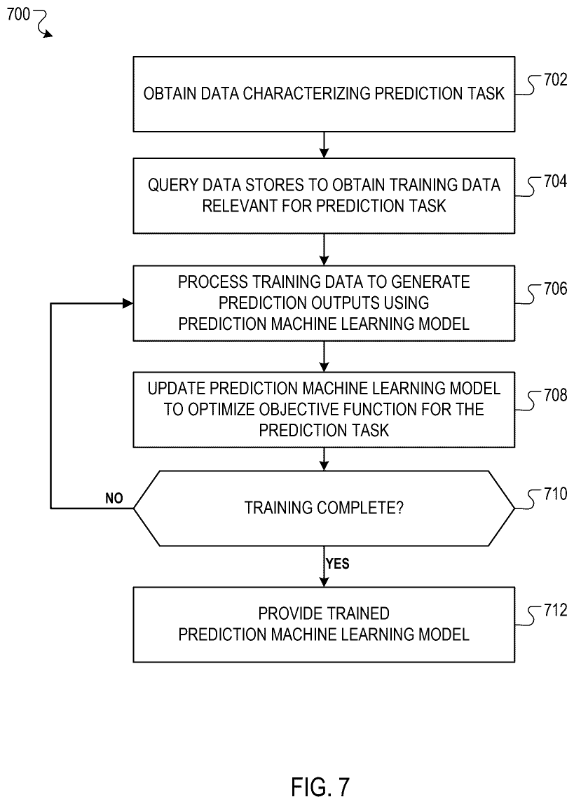

Example processes by which the data brief system 100 can train and use a prediction model to perform a prediction task as part of generating the data brief 102 are described in more detail below with reference to FIG. 6 and FIG. 7.

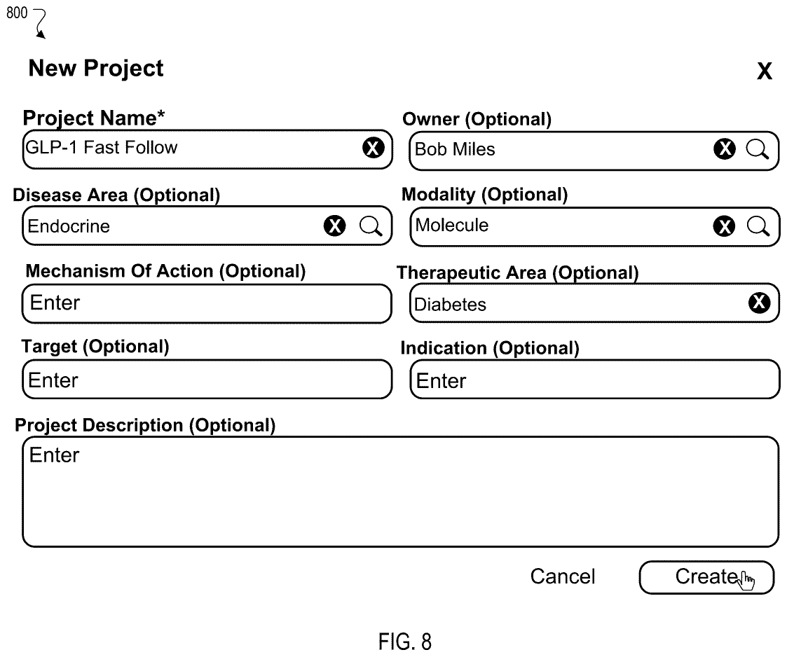

After generating the data brief 102, the data brief system 102 can present various representations of the data brief 102 to the user 102 by means of a user interface (UI) of the system 100. Examples of representations of the data brief 102 that the of that the system 100 can present to the user 106 are illustrated below in FIGS. 8-11.

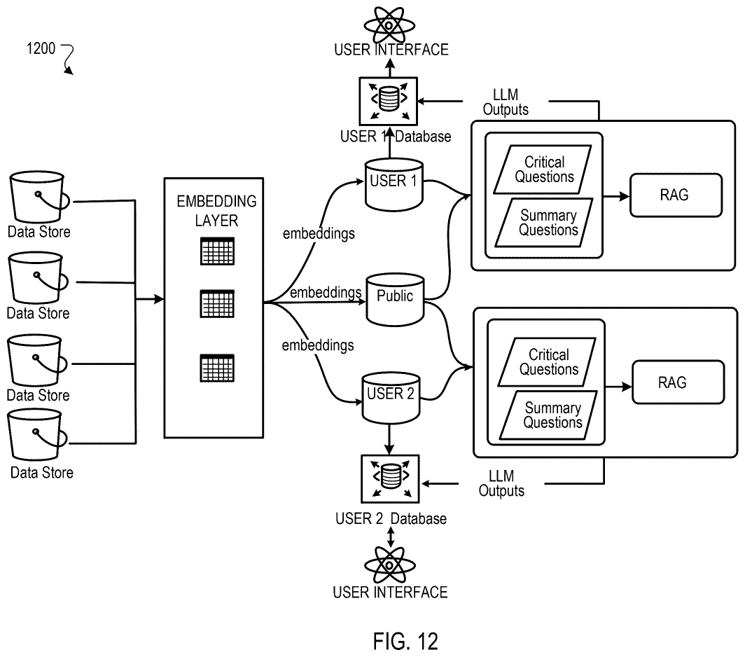

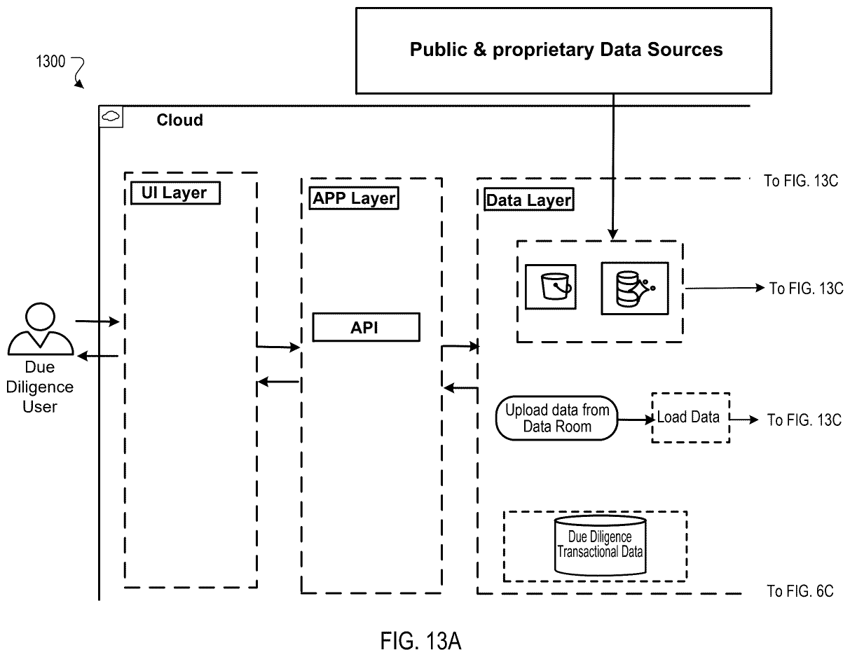

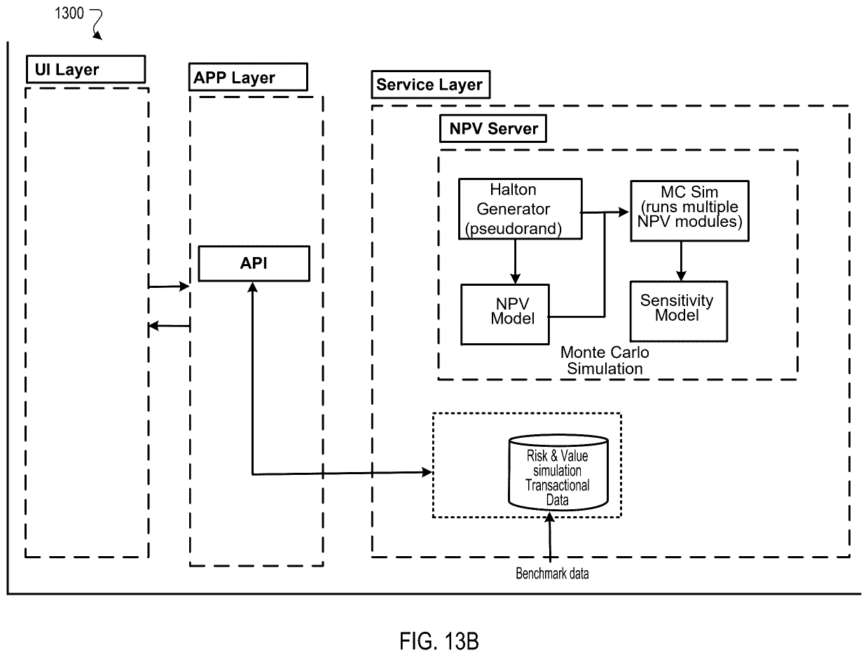

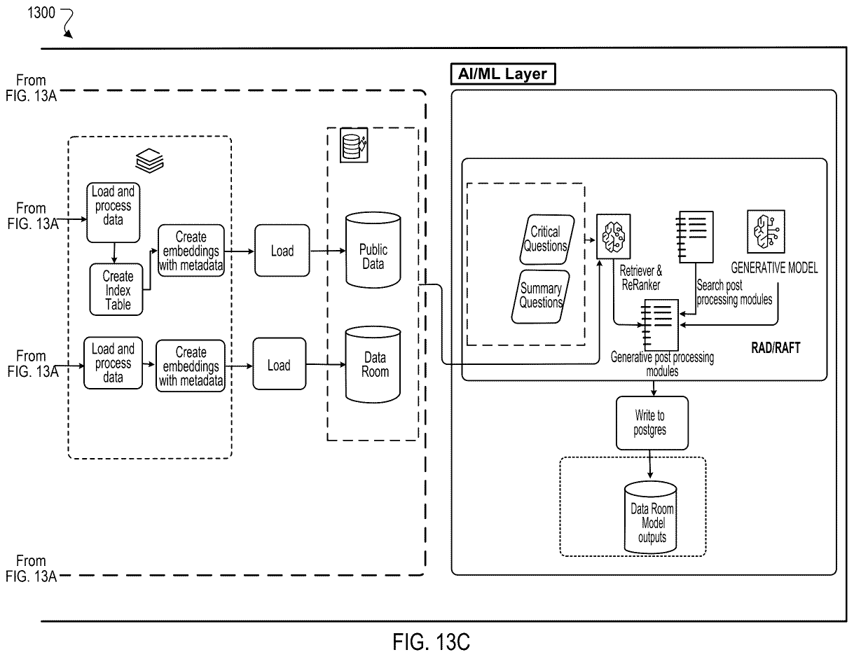

An example software implementation of the data brief system 100 is illustrated below in FIGS. 12-13C.

The data brief system 100 described in this specification can therefore efficiently generate user specific data briefs that can summarize and synthesize the structured and unstructured data stored within data stores for any of a variety of, e.g., projects, programs, cases, and so on.

As a particular example, the data stores 104 can include data relevant to a pharmaceutical drug, such as structured and unstructured data for the research and development of a pharmaceutical drug. When applied to a data room for a pharmaceutical drug, the system 100 can generate the data brief 102 to summarize findings and documentation regarding, e.g., a scientific and clinical viability of the drug (e.g., characterizing the mechanism of action of the drug; safety, efficacy, and tolerability data; a target disease indication of the drug; existence of backup series, etc.), production processes for the drug (e.g., manufacturing procedures and validation reports), safety and risk assessments (e.g., adverse events and outcomes data), and so on.

The system 102 can generate the data brief 102 to summarize various predictions for the drug, such as a net present value of the drug, a various of risk scores characterizing risks associated with the drug (e.g., risk scores for in vitro pharmacology, safety and toxicology, biomarkers, clinical trials, regulatory issues, etc.), and so on. In some implementations, the system can generate such predictions for the using one or more of the prediction models 122. For example, in some implementations the prediction models 122 can include a prediction model configured to process contents of the data stores 104 to generate a predicted net present value of the drug. As another example, in some implementations, the prediction models 122 can include one or more prediction models configured to predict respective risk scores for the drug.

FIG. 2 is a flow diagram of an example process 200 for automatically generating a data brief characterizing content from one or more data stores for a user. For convenience, the process 200 will be described as being performed by a system of one or more computers located in one or more locations. For example, a data brief system, e.g., the data brief system 100 of FIG. 1, appropriately programmed in accordance with this specification, can perform the process 200.

The system can determine a user category of the user (step 202). The user category for the user can be selected from a predefined set of user categories for the system. The system can determine the user category of the user by any appropriate method. For example, in some implementations, the user can select the user category from the predefined set of user categories by interacting with a user interface (UI) of the system. As another example, in some implementations, the system can process data associated with the user (e.g., a user ID, user account data, etc.) to determine the user category of the user.

The system can then generate a data brief that characterizes content from the data stores specific to the user category of the user over a sequence of one or more processing steps. In particular, at each processing step, the system can perform steps 204 through 208 as described below to generate, using a generative machine learning model and based on data accessed from one or more data stores, data included within the data brief for the user.

At each processing step, the system can determine a prompt for the generative machine learning model that is based on the user category of the user (step 204). In some implementations, the prompt for the generative machine learning model can be a predefined prompt that is associated with the user category of the user. For example, in some implementations, the system can store a sequence of predefined prompts associated with the user and can utilize a respective prompt from the sequence of predefined prompts at each of the processing steps for generating the data brief.

In some implementations, the system can select or generate the prompts for the generative machine learning model. For example, in some implementations, the system can select the prompt for each processing step from a plurality of pre-defined prompts associated with the user category of the user. As another example, in some implementations, the system can generate the prompt for each processing step by processing, e.g., data queried from the one or more data stores, data generated by the generative machine learning model at previous processing steps, and so on.

In some implementations, the system can generate the prompts for the generative machine learning model using one or more decision graphs. As described above, the decision graphs can include graph nodes that characterize instructions to perform particular tasks as part of generating the data brief. Each graph node of a decision graph can characterize instructions, e.g., to query particular data from the one or more data stores, to summarize or classify queried data from the one or more data stores, to perform a particular prediction task based on the queried data from the one or more the data stores, to process the queried data from the one or more data stores to generate a prompt for the generative machine learning model, and so on.

At each processing step, the system can perform tasks associated with one or more nodes from a decision graph to generate the prompt for the generative machine learning model, as described in more detail below with reference to FIGS. 3-5.

As part of selecting or generating the prompt for the generative machine learning model, the system can query the one or more data stores to obtain data that is predicted to be relevant to the prompt. In some cases, the system can process the queried data from the data stores as part of determining the prompt for the generative machine learning model, e.g., by selecting the prompt using a selection criteria that depends on some or all of the queried data, by processing some or all of the queried data to generate the prompt, and so on.

The system can perform any appropriate query of the one or more data stores to obtain the data predicted to be relevant to the prompt. For example, the system can query the one or more data stores to obtain contents that include particular keywords that are relevant to the prompt. As another example, the contents of the data stores can be stored with associated metadata (e.g., labels, tags, embeddings, and so on) and the system can query the one or more data stores to obtain contents of the one or more data store that are associated with particular metadata that is relevant to the prompt.

In some implementations, the system can generate some or all of the metadata for the contents of the data stores. For example, prior to generating data briefs using the contents of a data store, the system can process the contents of the data store (e.g., using the generative machine learning model) to generate the metadata for the contents of the data store.

The system can process the prompt for the processing step and data accessed from the one or more data stores using the generative model to generate a response for the processing step (step 206). In particular, at each processing step, the system can process a model input that includes the prompt for the processing step and using the generative machine learning model to generate a model output that represents the response to the prompt for the processing step.

In addition to the prompt for the processing step, the model input to the generative machine learning model can include at least a subset of data stored in the one or more data stores. For example, when the system queries the one or more data stores to obtain data that is relevant to the prompt, the system can include some or all of the queried data from the one or more data stores within the model input to the generative machine learning model.

As described above with reference to FIG. 1, the generative machine learning model can be a token processing neural network (e.g., a large language model, a vision-language model, a multi-modal language model, etc.) that is configured to generate a sequence of tokens that represents the response to the prompt for the processing step. In particular, the generative machine learning model can be configured to sequentially (e.g., auto-regressively) generate an output tokens that collectively define the model output by selecting a respective output token for each of a plurality of positions in the sequence of output tokens. The system can select the respective output token for each position of the output sequence of tokens by (i) processing the model input for the processing step and any previously generated output tokens of the output token sequence using the generative machine learning model to generate a score distribution over a set of possible tokens for the position (ii) selecting the output token for the position in the sequence of output tokens based on the score distribution over the set of possible tokens, e.g., by selecting a token having a highest score under the score distribution.

The system can then include the response for the processing step within the data brief (step 208). In particular, the system can include some or all of the model output generated by the generative machine learning model for the processing step within the data brief.

In some implementations, the system can identify supporting data stored in the data stores that support parts of the generated response and can include references to this supporting data within the data brief. The system can therefore include references within the data brief that indicate which contents of the data stores were queried and processed to generate particular portions of the data brief.

After generating the data brief (e.g., after a final processing step), the system can output a representation of the generated data brief (step 210). The system can output the representation of the generated data brief by any of a variety of means. For example, in some implementations, the system can output the representation of the generated data brief to another system, e.g., by way of an application programming interface (API) of the system. As another example, the system can provide the generated data brief to the user, e.g., by way of the user interface (UI) of the system.

In some implementations, the system can receive user feedback on the generated data brief by way of the user interface (UI) of the system (system 212). The system can receive various forms of user feedback. For example, in some implementations, the user feedback can include a user assigned rating or score for the generated data brief. As another example, when the system performs a prediction task using a prediction model as part of generating the data brief, the user feedback can include alternative input data for the prediction model.

When the system receives user feedback on the data brief, the system can update one or more models used to generate the data brief (e.g., the generative machine learning model, one or more prediction models used to perform prediction tasks as part of generating the data brief, etc.) (step 214). For example, when the user feedback includes a rating or score for the data brief, the system can use the rating or score for the data brief to fine-tune the generative machine learning model, e.g., by updating the current values of the set of machine learning model parameters of the generative machine learning model using a reinforcement learning with human feedback (RLHF) technique. As another example, when the user feedback includes alternative input data for a prediction model used to perform a prediction task for generating the data brief, the system can re-perform the prediction task by processing the alternative input data using the prediction model.

FIG. 3 illustrates example decision graphs that a data brief system (e.g., the data brief system 100 described above with reference to FIG. 1) can use as part of generating a data brief. As described above, the data brief system can store a plurality of different decision graphs and can select a particular decision graph to use when generating a data brief.

For example, as illustrated in FIG. 3, the data brief system can include category specific decision graphs 302-A through 302-N that are associated with respective user categories and can select a particular decision graph for generating the data brief based on a user category of the user. For example, the category specific decision graphs 302-A can include one or more decision graphs 304 through 306 that are associated with a first user category, the category specific decision graphs 302-N can include one or more decision graphs 308 through 310 that are associated with a last user category, and so on.

In some cases, the data brief system can select a particular decision graph to use to generate a data brief using additional criteria beyond the user category of the user. For example, in some cases, some or all of the category specific decision graphs 302-A through 302-N can include decision graphs associated with classes or groups of data stores and the data brief system can select the particular decision graph for generating the data brief based on which data stores are selected as the subject or references for the data brief. As another example, in some implementations, the user can select (e.g., by means of a user interface of the data brief system) the particular decision graph for generating the data brief from a plurality of category specific decision graphs that are associated with the user category of the user.

Each of the category specific decision graphs 302-A through 302-N can include graph nodes that characterize instructions to perform respective processing tasks as part of generating the data brief. For example, as illustrated in FIG. 3, the decision graph 306 includes the graph nodes 312 through 334.

Each decision graph can include a root node (e.g., an input node). For example, as illustrated in FIG. 3, the root node of the decision graph 306 is the node 312. When using a decision graph to generate a data brief, the data brief system can first perform the processing tasks associated with the root node of the decision tree. Based on the results of performing the processing tasks associated with the root node, the data brief system can select a child node of the root node and can then proceed to perform the processing tasks associated with the selected child node. By continuing in this manner (e.g., by performing the processing tasks associated with a current node in the decision graph and selecting a next node from among the child nodes of the current node), the data brief system can therefore generate the data brief using the decision graph by performing the tasks associated with a connected sequence (e.g., a path) of graph nodes within the decision graph.

In general, each decision graph can have any appropriate graph structure of directed edges connecting the graph nodes of the decision graph. For example, a decision graph of the data brief system can include graph nodes connected as a tree (e.g., with at most one unique path of graph edges connecting any two graph nodes of the decision graph). As another example, a decision graph can include graph nodes that are connected by one or more cycles of graph edges. For example, the decision graph 306 can include a cycle of graph edges connecting the graph nodes 314, 318, and 326, as illustrated in FIG. 3.

Each graph node of a decision graph can include instructions for performing any of a variety of processing tasks associated with the graph node. For example, a graph node of a decision graph can include instructions, e.g., to query particular data from the data stores, to summarize or classify queried data from the data stores, to perform a particular prediction task based on the queried data from the data stores, to process the queried data from the data stores to generate a prompt for the generative machine learning model, and so on.

In general, each graph node can include data characterizing one or more node specific queries of the data stores to perform to obtain input data for the processing tasks associated with the graph node. Depending on the processing tasks associated with a graph node, the graph node can include data characterizing particular model inputs to provide to particular models as part of performing the processing tasks associated with the node. For example, a graph node associated with performing a prediction task using a prediction model can include data characterizing particular model inputs (e.g., queried data values, generative machine learning model outputs, etc.) to provide to the prediction model to perform the prediction task associated with the graph node. As another example, a graph node associated with generating prompt for a generative machine learning model (e.g., the generative machine learning model 110 of FIG. 1) can include data characterizing particular model inputs, e.g., natural language text, queried data, prediction model outputs, and so on, to include within the prompt for the generative machine learning model.

Additionally, each graph node can include data characterizing decision criteria for selecting a next node after performing the processing task associated with the graph node. In general, the decision criteria for a graph node can specify how the data brief system selects a next node based on the results of performing the processing tasks associated with the graph node, e.g., based on data queried from the data stores while performing the processing tasks associated with the node, prediction outputs generated by one or more prediction models while performing the processing tasks associated with the node, output data generated by the generative machine learning model while performing the processing tasks associated with the node, and so on.

As an example, the node 316 illustrated in FIG. 3 can include data characterizing node-specific queries 316-A and model inputs 316-B for performing the processing tasks associated with the node 316 and can include data characterizing decision criteria 316-C for use in selecting a next graph node after performing the processing tasks associated with the node 316.

In some implementations, the graph nodes of a decision graph can include data specifying pre-defined instructions for performing tasks. The graph nodes of a decision graph can include, e.g., pre-defined queries to perform to obtain data from the data stores, pre-defined computations or predictions to perform using the queried data, pre-defined prompts to provide to the generative machine learning model, pre-defined templates for generating prompts to provide to the generative machine learning model, pre-defined operations to perform to include data generated by the generative machine learning model within the data brief, and so on.

In some implementations (e.g., when the data brief system is a language model agent system), the graph nodes of a decision graph can include high-level descriptions (e.g., natural language text descriptions) of tasks to perform as part of generating the data brief. The graph nodes of a decision graph can include, e.g., include high-level descriptions (e.g., natural language text descriptions) of, e.g., data to query from the data stores, computations or predictions to perform using the queried data, formats and/or contents of prompts for the generative machine learning model, how data generated by the generative machine learning model should be included within the data brief, and so on. When the data brief system is a language model agent system, a planning language model agent (e.g., the query system 116 of FIG. 1) of the data brief system can process such high-level descriptions for a graph node to coordinate performing the processing tasks associated with the graph node, e.g., by querying the data stores of the data brief system, preparing and providing prompts to the generative machine learning model of the data brief system, by preparing and providing model inputs to one or more specialized prediction models of the data brief system, and so on.

In general, the data brief system can finish using a decision graph to generate the data brief when the data brief system performs the processing tasks associated with a leaf node of the decision graph (e.g., a graph node of the decision graph that has no child nodes). In some cases, a leaf node of a decision graph can characterize instructions to finish preparing the data brief for the user (e.g., to generate and output a final representation of the data brief for the user). In other cases, a leaf node of a decision graph can include instructions to continue generating the data brief using another decision graph of the data brief system.

As described above with reference to FIG. 2, the data brief system can use the decision graphs to generate a data brief over a sequence of one or more processing steps. At each processing step of generating the data brief, the data brief system can perform the processing tasks associated with a connected path of graph nodes through a portion of the decision graph (e.g., a path of connected graph nodes between an input graph node for the processing step and an output graph node for the processing step) to determine a prompt to provide to the generative machine learning model during the processing step.

The input graph node for the first processing step of generating a data brief can be the root node of the decision graph. For each subsequent processing step of generating the data brief, the input graph node for the processing step can be a selected child node of the output graph node of the preceding processing step (e.g., as selected based on the decision criteria of the output graph node of the preceding processing step).

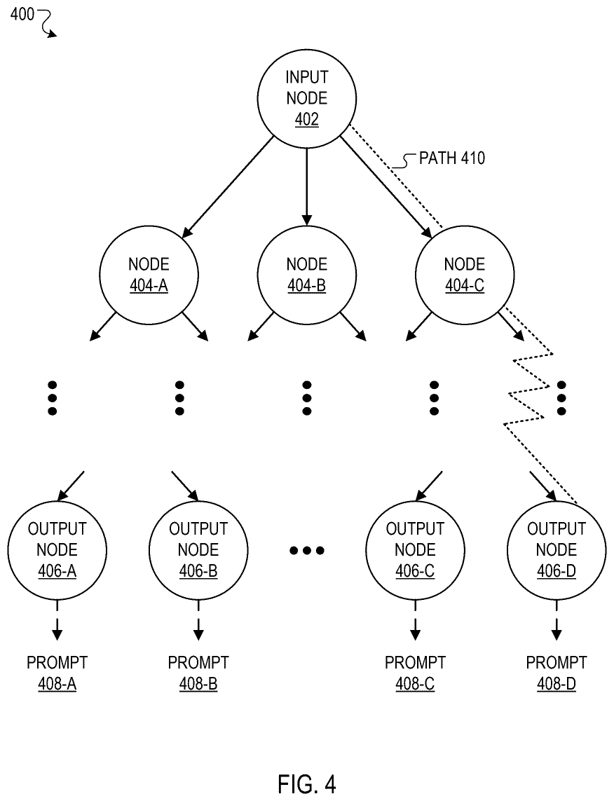

FIG. 4 illustrates determining a prompt for a generative machine learning model using a decision graph as part of a processing step of generating a data brief.

As described above, during the processing step, the data brief system can perform the processing tasks associated with graph nodes of a subgraph 400 of the decision graph, starting from an input node 402 for the processing step and ending at one of a set of possible output nodes for the processing step.

As illustrated in FIG. 4, the subgraph 400 includes the input node 402 for the processing step as a root node of the subgraph 400 and a set of one or more possible output nodes for the processing step as leaf nodes of the subgraph 400. The set of possible output nodes of the subgraph 400 for the processing step can include each of the descendent nodes of the input node 402 for the processing step that include instructions for selecting or generating respective prompts for the generative machine learning model of the data brief system during the processing step.

The subgraph 400 for the processing step can include one or more non-output nodes between the input node 402 for the processing step and the set of possible output nods for the processing step. In general, the non-output nodes of the subgraph 400 for the processing step can include the input node 402 for the processing step and any graph nodes of the decision graph between the input node 402 for the processing step and the set of possible output nodes for the processing step that do not include instructions for selecting or generating respective prompts for the generative machine learning model of the data brief system during the processing step.

For illustrative purposes, FIG. 4 depicts the non-output nodes of the subgraph 400 for the processing step as including the input node 402, the child nodes 404-A through 404-B of the input node, and additional descendant nodes of the input node (which are depicted in FIG. 4) leading to the set of possible output nodes for the processing step. FIG. 4 depicts the set of possible output nodes for the processing step as including the output nodes 406-A through 406-D, which are each associated with instructions for selecting or generating respective prompts 408-A through 408-D for the generative machine learning model of the data brief system during the processing step.

However, a subgraph for a processing step can, in general, include any number of non-output nodes. For example, the subgraph of a decision graph for a processing step can include zero non-output nodes when the input node for the processing step is also an output node for the processing step (e.g., the input node for the processing step includes instructions for selecting or generating a prompts for the generative machine learning model).

As described above with reference to FIG. 3, the data brief system can determine a prompt for the generative machine learning model during the processing step by performing processing tasks associated with each graph node within a path (e.g., a connected sequence) of graph nodes of the subgraph 400 that connects the input node 402 for the processing step to one of the possible output nodes for the processing step. For example, as illustrated in FIG. 4., the data brief system can determine the prompt for the generative machine learning model during the processing step using the decision graph by performing the processing tasks associated with the graph nodes along a path 410 through the subgraph 400. As described above, the data brief system can dynamically determine the graph nodes of the path 410 based on the results of performing the processing tasks associated with preceding graph nodes in the path 410.

For example, based on the results from the processing tasks associated with the input node 402, the data brief system can select the node 404-A as the next node of the path 410. Similarly, based on the results from the processing tasks associated with each of the preceding nodes of the path 410, the data brief system can select the output node 406-D as the final node of the path 410, resulting in the data brief system processing the prompt 408-D using generative machine learning model during the processing step.

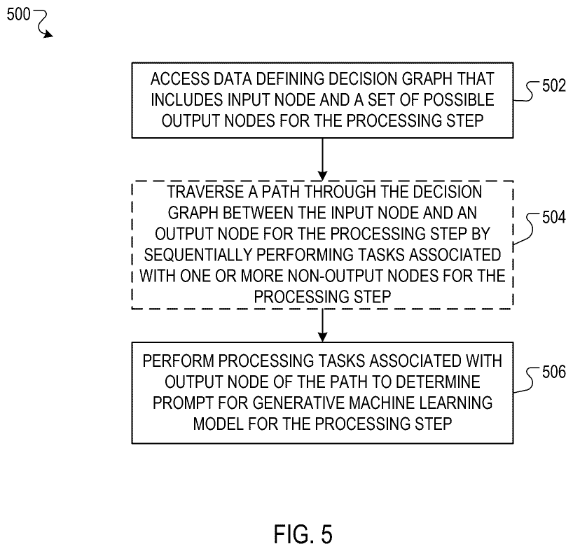

FIG. 5 is a flow diagram of an example process 500 of using a decision graph to determine a prompt for a generative machine learning model. For convenience, the process 500 will be described as being performed by a system of one or more computers located in one or more locations. For example, a data brief system, e.g., the data brief system 100 of FIG. 1, appropriately programmed in accordance with this specification, can perform the process 500.

As described above with reference to FIG. 2, the system can generate a data brief using a generative machine learning model over a sequence of processing steps. At each processing step, the system can perform the process 500 described below to select or generate a prompt for the generative model during the processing step using the decision graph.

As described above, before performing the processing steps to generate the data brief, the system can select the decision graph for generating the data brief based on any of a variety of criteria. For example, the system can include a plurality of decision graphs that are associated with different user categories and can select the decision graph for generating a data brief for a given user based on a user category for the user. As another example, the system can include a plurality of decision graphs that are associated with different classes of data stores and can select the decision graph for generating a data brief summarizing the contents of a given data store based on the class of the given data store. As another example, a user of the system can select the decision graph for generating the data brief from a plurality of decision graphs stored by the system.

The system can access data defining the decision graph to identify a subgraph of the decision graph for the processing step (step 502). As described above with reference to FIG. 3, the subgraph of the decision graph for the processing step can include an input node for the processing step and a set of one or more possible output nodes for the processing step. Each output node for the processing step can be a graph node of the decision graph that includes instructions to select or generate a respective prompt for the generative machine learning model during the processing step.

The subgraph for the processing step can include any number of non-output nodes from the decision graph that connect the input node for the processing step to the set of possible output nodes for the processing step. For example, the input node for the processing step and any number of descendants of the input node for the processing step can be non-output nodes for the processing step. As another example, in some cases, the input node for the processing step can be an output node for the processing step and the subgraph for the processing step can include zero non-output nodes.

For a first processing step of generating the data brief, the input node for the processing step can be a root node of the decision graph. For each subsequent processing step of generating the data brief, the input node for the processing step can be a child node of the output node of a previous processing step.

The system can then sequentially traverse a path from the input node for the processing step to an output node for the processing step to determine the prompt for the generative model for the processing step.

When the subgraph for the processing step includes non-output nodes, the system can sequentially perform processing tasks associated with a sequence of one or more non-output nodes to traverse the path from the input node for the processing step to the output node for the processing step (step 504).

As described above with reference to FIG. 3, each non-output graph node of the decision graph can include instructions for performing any of a variety of processing tasks associated with the graph node. For example, a non-output graph node of a decision graph can include instructions, e.g., to query particular data from the data stores, to summarize or classify queried data from the data stores, to perform a particular prediction task based on the queried data from the data stores, and so on. Each non-output graph node of the decision graph can also include data characterizing decision criteria for the non-output graph node that the system can evaluate to select a next node in the path through the decision graph. In particular, the system can evaluate the decision criteria for each non-output node in the path to select a child node of the non-output node as a next node in the path (e.g., by identifying an edge that connects the non-output node to the selected child node of the non-output node).

The system can therefore traverse the path from the input node for the processing step to the output node for the processing step by performing the processing tasks associated with each non-output graph node in the path and selecting a next node in the path using the decision criteria for the non-output graph node.

In some cases, a non-output node can include instructions to perform a particular prediction task and can include decision criteria for selecting a next node in the path based on prediction results from performing the particular processing task. When a non-output node includes instructions to perform a particular processing task, the system can perform the particular processing task using a specialized prediction model, e.g., following the process 600 described below with reference to FIG. 6.

In some cases a non-output graph node can include instructions to classify data within one or more data stores for the data brief and can include decision criteria for selecting a next node in the path based on classification of the data within the one or more data stores. In particular, the non-output graph node can specify a classification criterion that the system can use to determine the classification of the data within the one or more data stores for the non-output graph node. For example, in some implementations, the system can classify the data within the one or more data stores by evaluating a classification criterion for the non-output node based on metadata (e.g., labels, tags, embeddings, etc.) stored alongside the data within the one or more data stores.

As another example, in some implementations, the system can classify the data within the one or more data stores by evaluating a classification criterion for the non-output node using a machine learning model (e.g., the generative machine learning model, a language model agent of the system, etc.). As a further example, the classification criterion for the non-output node can specify how the machine learning model should determine a classification of the data for the non-output node and the system can classify the data for the non-output node by using the machine learning model to processing a model input that includes (i) the classification criterion for the non-output node and (ii) at least a subset of the data stored in the data stores.

In some implementations, the non-output node can specify a query to perform of the one or more data stores to obtain data that is predicted to be relevant to generating the classification of the data for the non-output node. The system can perform the query of the one or more data stores to automatically extract such relevant data and can include the queried data within the model input to the machine learning model for generating the classification for the non-output node.

The system can then perform processing tasks associated with the output node of the path to select or generate the prompt for the generative machine learning model for the processing step (step 506). In some cases, the output node of the path can include data specifying a pre-defined prompt associated with the output node.

In other cases, the output node of the path can include data characterizing instructions for generating the prompt for the generative machine learning model using data queried from the data stores and/or data generated by machine learning models of the system while performing the processing tasks associated with the graph nodes of the path. For example, the output node can include data specifying a pre-defined prompt template into which the system can insert previously queried or generated data to generate the prompt for the generative machine learning model. As another example, when the system is a language model agent system, the output node can include a high-level description (e.g., a natural language text description) that a language model agent can process alongside previously queried or generated data to generate the prompt for the generative machine learning model.

FIG. 6 is a flow diagram of an example process 600 of performing a prediction task as part of generating a data brief. For convenience, the process 600 will be described as being performed by a system of one or more computers located in one or more locations. For example, a data brief system, e.g., the data brief system 100 of FIG. 1, appropriately programmed in accordance with this specification, can perform the process 600.

As described above with reference to FIG. 1, the system can perform any of a variety of prediction tasks as part of generating the data brief. For example, the prediction task can be a classification task, a regression task, a forecasting task, and so on. In some cases, the prediction task can be a probabilistic modeling task that involves generating a predicted probability distribution over a range of possible values of an entity characterized by the data stores

The system can query one or more data stores to obtain data relevant to performing the prediction task (step 602). For example, the system can query the one or more data stores to obtain contents that include particular keywords that are relevant to the prediction task. As another example, the contents of the data stores can be stored with associated metadata (e.g., labels, tags, embeddings, and so on) and the system can query the one or more data stores to obtain contents of the one or more data store that are associated with particular metadata that is relevant to the prediction task.

The system can process the queried data to prepare input data for performing the prediction task using a specialized prediction model for the prediction task (step 604). In general, the system can prepare the input data for the prediction task by processing the queried data to determine a respective input value for each parameter in a set of parameters of the input data.

In some cases, the system can directly determine the input values for the parameters of the input data for the prediction task by querying the data stores. For example, the data stores can include structured input data (e.g., database entries, spreadsheet tables, etc.) for the prediction task.

In other cases (e.g., when the data stores include unstructured input data for the prediction task, such as text documents relating to the prediction task), the system can process the queried data using a machine learning model to extract the input values for the parameters of the input data. For example, for each of the parameters of the input data, the system can use a generative machine learning model (e.g., the generative machine learning model 110 of FIG. 1, a language model agent of the system, and so on) to generate a model output that defines the input value for the parameter by processing a model input that includes (i) an instruction to determine the value of the parameter and (ii) some or all of the queried data for the processing task.

The system can process the prepared input data using the specialized prediction model to generate a prediction output for the prediction task (step 606). As described above, the specialized prediction model can be any appropriate model for performing the prediction task. For example, in some cases, the prediction model can be a machine learning model, such as a random forest model, a neural network model, a linear regression model, a support vector machine model and so on. When the prediction model is a machine learning model, the prediction model can be trained on a set of training examples by a machine learning training technique using any appropriate objective function for the prediction task (e.g., following the process 700 described below with reference to FIG. 7). As another example, in some cases, the prediction model can be a simulation model, such as a Monte Carlo model.

In some cases, the prediction model can be an ensemble model that includes a plurality of distinct computational models that collectively form the prediction model.

In some cases, the system can determine an uncertainty measure that characterizes an uncertainty in the prediction generated by the prediction model. For example, in some implementations, the prediction model can be configured to generate a predicted uncertainty measure for the prediction in addition to generating the prediction. As another example, when the prediction model is an ensemble model, the system can determine the uncertainty measure based on an uncertainty (e.g., a variance, a standard deviation, etc.) of the individual predictions from the models that collectively form the prediction.

The system can then utilize the generated prediction output for the prediction task as part of generating the data brief (step 608). The system can, e.g., include the prediction output within the data brief, process the prediction output to generate data to include within the data brief, use the prediction output to select processing tasks to perform as part of generating the data brief, and so on.

FIG. 7 is a flow diagram of an example process 700 of dynamically training a specialized prediction model to perform a prediction task as part of generating a data brief. For convenience, the process 700 will be described as being performed by a system of one or more computers located in one or more locations. For example, a data brief system, e.g., the data brief system 100 of FIG. 1, appropriately programmed in accordance with this specification, can perform the process 700.

The system can obtain data characterizing the prediction task to be performed as part of generating the data brief (step 702). In general, the data characterizing the prediction task can specify model inputs for the prediction task and model outputs for the prediction task.

The system can obtain the data characterizing the prediction task from various sources as part of generating a data brief for a user. For example, in some implementations, the system can receive data specifying the prediction task from a user of the system (e.g., by means of a user interface of the system). As a further example, in some implementations, the system can perform the process 700 to dynamically train a prediction model to perform a prediction task requested by the user.

As another example, in some cases, the system can obtain the data specifying the prediction task from a decision graph for generating the data brief. As a further example, in some implementations, the system can perform the process 700 to dynamically train a prediction model to perform a prediction task as specified by a graph node of a decision graph for generating the decision graph.

The system can query one or more data stores to obtain training data relevant for the prediction task (step 704). For example, the system can query the one or more data stores to obtain contents that include particular keywords that are related to the prediction task. As another example, the contents of the data stores can be stored with associated metadata (e.g., labels, tags, embeddings, and so on) and the system can query the one or more data stores to obtain contents of the one or more data store that are associated with particular metadata for the prediction task.

In general, the system can prepare the training data for the prediction task by processing the queried data to generate a plurality of training examples that each include a training input for the prediction task (e.g., including example values for each of a set of input parameters for the prediction task) and a target output for the prediction task (e.g., including target values for each of a set of output parameters for the prediction task).

In some cases, the system can directly determine the training inputs and target outputs for the training examples by querying the data stores. For example, the data stores can include structured data (e.g., database entries, spreadsheet tables, etc.) representing training examples for the prediction task.

In other cases (e.g., when the data stores include unstructured data for the prediction task, such as text documents relating to the prediction task), the system can process the queried data using a machine learning model to extract values for the training inputs and target outputs for the training examples. For example, for each of the input and output parameters for a training example, the system can use a generative machine learning model (e.g., the generative machine learning model 110 of FIG. 1, a language model agent of the system, and so on) to generate a model output that defines the input value for the parameter by processing a model input that includes (i) an instruction to determine the value of the parameter and (ii) some or all of the queried data for the processing task.

After obtaining the training data for the prediction task, the system can train the structure prediction generative model over a sequence of training iterations. At each training iteration, the system can perform steps 706 through 710.

The system can then process the input data for a plurality of training examples for the training iteration using the prediction machine learning model to generate predicted outputs for the training iteration (step 706).

The system can update model weights of the prediction machine learning model to optimize an objective function for the prediction task (step 708). In general, the objective function for the prediction task can measure any appropriate discrepancy (e.g., error) between the predicted outputs generated by the prediction machine learning model for the training examples and the corresponding target outputs for the training examples. For example, when the prediction task is a classification task, the objective function can measure a cross-entropy error between the predicted outputs generated by the prediction machine learning model for the training examples and the corresponding target outputs for the training examples. As another example, when the prediction task is a regression or a forecasting task, the objective function can measure, e.g., a mean-squared error, a mean average error, and so on between the predicted outputs generated by the prediction machine learning model for the training examples and the corresponding target outputs for the training examples. As another example, when the prediction task involves generating data characterizing a probability distribution based on the model inputs for the prediction task, the objective function can measure a divergence (e.g., a Kullback-Leibler divergence) between the probability distributions defined by the predicted outputs generated by the prediction machine learning model for the training examples and the corresponding target outputs for the training examples.

As part of updating the model weights of the prediction machine learning model, the system can determine gradients of the objective function (e.g., gradients of the objective function with respect to the model weights of the prediction machine learning model). The system can update the model weights of the prediction machine learning model using the gradients of the objective function following any appropriate machine learning technique (e.g., following stochastic gradient descent, ADAM, etc.).

The system can determine whether the training is complete (step 710). The system can use any of a variety of criteria to determine whether the training is complete. For example, the system can determine that training is complete after a pre-determined number of training iterations. As another example, the system can determine that training is complete when a value of the objective function falls below a pre-determined threshold. As another example, the system can determine that training is complete when a difference between values of the objective function for the current training iteration and a previous training iteration falls below a pre-determined threshold.

If the system determines that training is not complete, the system can continue to a next training iteration (e.g., return to step 706)

When the system determines that training is complete, the system can provide the trained prediction machine learning model (step 712).

FIG. 8 illustrates an example of a first user interface 800 that a data brief system can present to a user, e.g., on a display of a user device. In this example, the user can use the system to generate a data brief for a data room that includes data characterizing a drug, in this case, a GLP-1 receptor agonist drug. The user can enter additional information by way of the user interface 800 that the system can use, e.g., to determine a user category of the user, to construct the prompt that is provided to the generative model, or both.

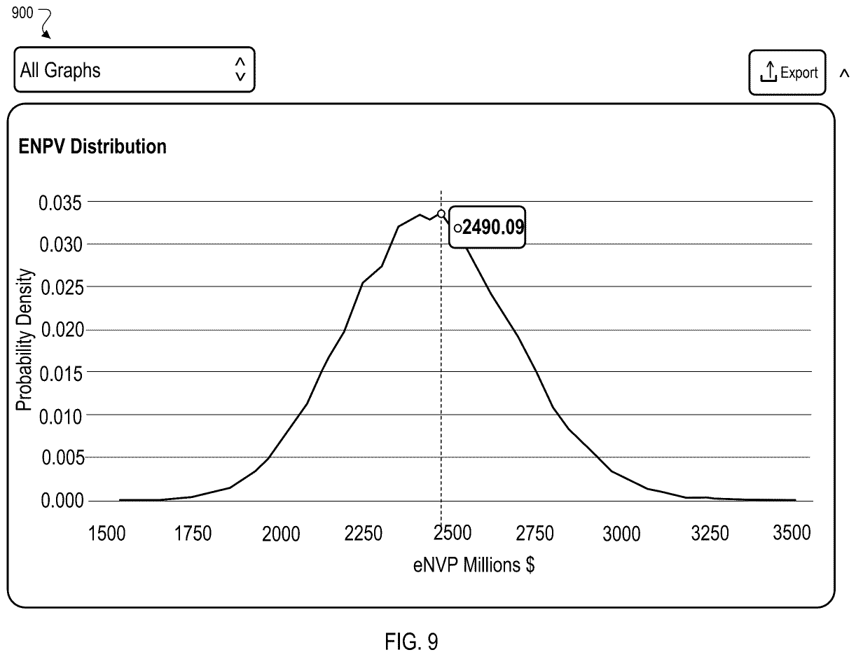

FIG. 9 illustrates an example representation 900 of a prediction generated by a specialized computational prediction model that is separate from the generative model. In this example, the prediction model generates a probability distribution over a range of possible expected net present value (ENPV) possibilities for the drug. The prediction model can be implemented, e.g., as a Monte Carlo prediction model.

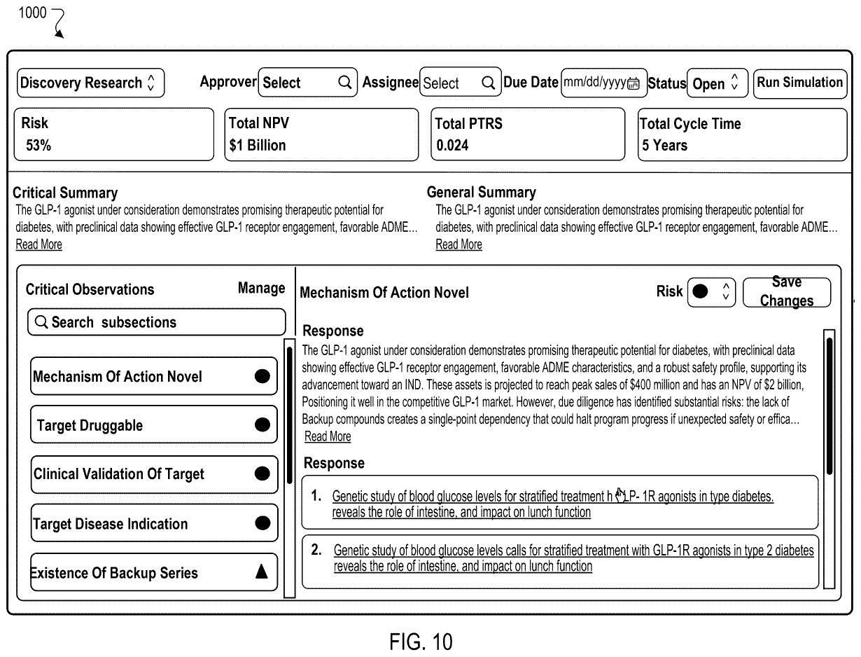

FIG. 10 illustrates an example of a second user interface 1000 that a data brief system can present a user to navigate a data brief generated by the system for a data store that includes information characterizing a drug, in this case, a GLP-1 receptor agonist drug. The data brief includes qualitative information (e.g., “due diligence has identified substantial risks”) and quantitative information (e.g., “Total NPV: $1 Billion”) characterizing the drug.

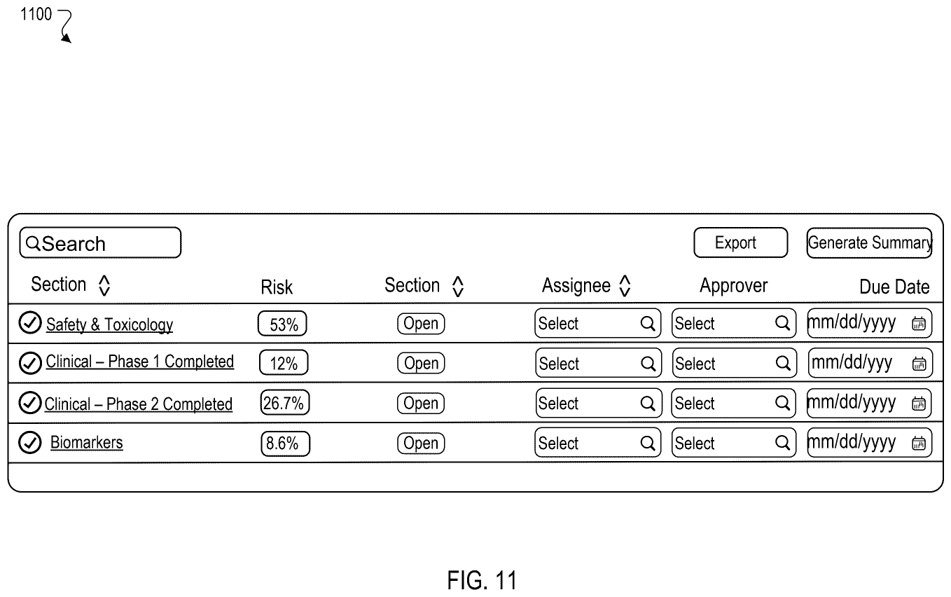

FIG. 11 illustrates an example of a third user interface 1100 that a data brief system can present to a user to view individual risk scores generated by the system for each category in a schema of categories. In some cases, the system generates the risk scores at least in part using specialized computational prediction models that are separate from the generative model.

FIG. 12 illustrates an example of a data flow 1200 that can be implemented by a data brief system as described in this specification. The system accesses a variety of data stores to obtain data which is then provided to an embedding layer which generates embeddings of the data from the data stores, e.g., using an embedding model. The data stores can include both proprietary data stores (e.g., that are access-controlled data stores maintained or licensed by the user) and public data stores (e.g., that are publicly available). The system can leverage the data stores to provide data briefs to multiple users in different user categories, e.g., the underlying data store can include content characterizing a drug, “user 1” can be, e.g., a toxicologist, and “user 2” can be, e.g., a regulatory specialist. For each user, the system can generate a prompt that is specific to the user category of the user (e.g., including “Critical Questions” and “Summary Questions”), extract content from the data stores that is relevant to answering the prompt using the embeddings of the content in the data stores, generate a data brief for the user by processing the user-specific prompt and the extracted data using the generative model (and, optionally, one or more specialized computational models), e.g., by a process that includes retrieval augmented generation (“RAG”), and then provide the data brief to the user by way of a user interface.

FIG. 13A-FIG. 13C illustrate an example of a software stack 1300 that can be used to implement a data brief system as described in this specification. In this example, the user is a “due diligence user,” e.g., that uses the system as part of performing due diligence on an entity (e.g., a drug), where the underlying data store includes data characterizing the entity. The software stack includes a user interface (UI) layer, an application (APP) layer that includes an application programing interface (API), a data layer, a service layer, and an AI/ML layer.

The UI layer can provide a user interface, e.g., a graphical user interface, to the user on a display of a user device. The API made available by the APP layer can enable inputs provided to the UI to be routed to the other layers in the stack, and can enable outputs (e.g., data briefs) generated by the other layers in the stack to be routed back to the UI layer. The data layer can manage storage of and access to public and proprietary data stores such as, in this case, “due diligence transactional data.” The data layer also creates embeddings of data stored in the data stores to facilitate retrieval of relevant data for inclusion in model inputs processed by the generative model implemented in the AI/ML layer. The service layer can include specialized computational prediction models such as, in this case, a Net Present Value (NPV) server that can generate a predicted net present value of entity (e.g., the drug characterized by the data store) using a Monte Carlo simulation pipeline that includes a Halton Generator, a Monte Carlo Simulator, a Sensitivity Model, and an NPV model. The AI/ML layer includes modules that generate the prompt based on the user category of the user, obtain relevant data extracted from the data stores, process the prompt and the data extracted from the data stores using the generative model (and, optionally, specialized computational model implemented in the service layer), and generate the data brief.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
determining a user category of a user, wherein the user category is selected from a predefined set of user categories;
generating, using a generative machine learning model and based on data accessed from one or more data stores, a data brief that characterizes content from the data stores that is specific to the user category of the user, comprising:
determining a prompt for the generative machine learning model that is based on the user category of the user;
processing a model input that comprises: (i) the prompt based on the user category of the user, and (ii) at least a subset of data stored in the data stores, using the generative machine learning model to generate a model output that is responsive to the prompt; and
including the model output generated by the generative machine learning model in the data brief; and
providing, to the user and by way of the user interface, a representation of the data brief generated using the generative machine learning model.

2. The method of claim 1, further comprising:
accessing the data stores to automatically extract data stored in the data stores that is predicted to be relevant to the prompt; and
including the data extracted from the data stores that is predicted to be relevant to the prompt in the model input that is processed by the generative machine learning model to generate the model output that is included in the data brief.

3. The method of claim 1, wherein determining the prompt for the generative machine learning model comprises:
accessing data defining a decision graph that is associated with the user category of the user, wherein each output node of the decision graph is associated with a respective prompt;
sequentially traversing a path from an input node of the decision graph to an output node of the decision graph, comprising, at each non-output node in the path:
determining a classification of data stored in the data stores into a class from a predefined set of classes based on a classification criterion that is specific to the non-output node; and
identifying an edge that connects the non-output node to a child node of the non-output node and that is associated with the determined class of the data stored in the data stores; and
selecting the child node of the non-output node as a next node in the path; and
identifying the prompt associated with the output node in the path as the prompt for the generative machine learning model.

4. The method of claim 1, wherein determining the prompt for the generative machine learning model comprises:
accessing data defining a decision graph that is associated with the user category of the user, wherein each output node of the decision graph is associated with a respective prompt; and
determining a sequence of one or more prompts for the generative machine learning model over a sequence of one or more processing steps, comprising, at each processing step:
sequentially traversing a path from an input node of the decision graph for the processing step to an output node of the decision graph for the processing step, comprising, at each non-output node in the path:
performing the processing task associated with the non-output node using a subset of data stored in the data stores; and
selecting a child node of the non-output node as a next node in the path by applying a decision criteria for the non-output node based on a result of performing the processing task associated with the non-output node; and
including a prompt associated with the output node in the path within the sequence of one or more prompts for the generative machine learning model.

5. The method of claim 4, wherein, for some or all of the non-output nodes in the path, performing the processing task associated with the non-output node using the subset of data stored in the data stores comprises:
determining a classification of the subset of data stored in the data stores into a class from a predefined set of classes based on a classification criterion that is specific to the non-output node.

6. The method of claim 4, wherein, for some or all of the non-output nodes in the path, performing the processing task associated with the non-output node using the subset of data stored in the data stores comprises:
obtaining the subset of data stored in the data stores by performing a query specified by the non-output node.

7. The method of claim 4, wherein determining the sequence of one or more prompts for the generative machine learning model over the sequence of one or more processing steps comprises, at each processing step after the first processing step:
determining the input node for the processing step based on a decision criteria of the output node for a preceding processing step.

8. The method of claim 3, wherein for each non-output node in the path, determining the classification of data stored in the data stores based on the classification criterion that is specific to the non-output node comprises:
determining the classification of data stored in the data stores based on the classification criterion that is specific to the non-output node using the generative machine learning model.

9. The method of claim 8, wherein for each non-output node in the path, determining the classification of data stored in the data stores based on the classification criterion that is specific to the non-output node using the generative machine learning model comprises:
processing a model input that comprises: (i) the classification criterion that is specific to the non-output node, and (ii) at least a subset of the data stored in the data stores, using the generative machine learning model to generate the classification of the data stored in the data stores.

10. The method of claim 9, further comprising:
accessing the data stores to automatically extract data stored in the data stores that is predicted to be relevant to the classification of the non-output node; and
including the data extracted from the data stores that is predicted to be relevant to the classification of the non-output node in the model input that is processed by the generative machine learning model to generate the classification of the data stored in the data stores.

11. The method of claim 1, further comprising:
determining, for each parameter in a set of parameters, a respective value for the parameter by querying the data stores using the generative machine learning model;
processing the set of parameters using a prediction model to generate a prediction characterizing the data stored in the data stores; and
including the prediction generated by the prediction model in the data brief.

12. The method of claim 11, wherein for each parameter in the set of parameters, determining the value for the parameter by querying the data stores using the generative machine learning model comprises:
processing a model input that comprises: (i) an instruction to determine the value of the parameter, and (ii) at least a subset of the data stored in the data stores, using the generative machine learning model to generate a model output that defines the value for the parameter.

13. The method of claim 11, further comprising:
accessing the data stores to automatically extract data stored in the data stores that is predicted to be relevant to determining the value of the parameter; and
including the data extracted from the data stores that is predicted to be relevant to determining the value of the parameter in the model input that is processed by the generative machine learning model to generate the model output that defines the value for the parameter.

14. The method of claim 1, further comprising:
receiving, from the user, an additional user input that defines a prediction task to be performed based on the content of the data stores; and
in response to receiving the additional user input defining the prediction task:
generating a set of training examples for training a prediction model to perform the prediction task by querying one or more training data stores using the generative machine learning model;
dynamically training a prediction model on the set of training examples by a machine learning training technique to configure the prediction model to perform the prediction task;
processing a model input derived from the data stores using the prediction model to generate a prediction output; and
including the prediction output in the data brief.

15. The method of claim 14, wherein for each training example in the set of training examples, generating the training example by querying a training data store using the generative machine learning model comprises:
processing a model input that comprises: (i) an instruction to extract values of a set of input parameters and a target output, and (ii) at least a subset of data stored in the training data store, using the generative machine learning model to generate a model output that comprises the values of the set of input parameters and the target output; and
generating a training example that includes: (a) the values of the set of input parameters as a training input, and (b) the value of the target output as a prediction target to be generated by the prediction model by processing the training input.

16. The method of claim 1, further comprising:
receiving user feedback on the data brief by way of the user interface; and
updating current values of: (i) a set of machine learning model parameters of the generative machine learning model, or (ii) one or more parameters of a prediction model that is used to generate the data brief, based on the user feedback.

17. The method of claim 16, wherein the user feedback comprises a rating for the data brief; and
wherein updating current values of: (i) a set of machine learning model parameters of the generative machine learning model, or (ii) one or more parameters of a prediction model that is used to generate the data brief, based on the user feedback comprises:
updating the current values of the set of machine learning model parameters of the generative machine learning model using a reinforcement learning with human feedback (RLHF) technique.

18. The method of claim 16, wherein the user feedback comprises an alternative value for a parameter of the prediction model; and
wherein updating current values of: (i) a set of machine learning model parameters of the generative machine learning model, or (ii) one or more parameters of a prediction model that is used to generate the data brief, based on the user feedback comprises:
re-running the prediction model using the alternative value for the parameter of the prediction model.

19. One or more non-transitory computer storage media storing instructions that when executed by one or more computers cause the one or more computers to perform operations comprising:
determining a user category of a user, wherein the user category is selected from a predefined set of user categories;
generating, using a generative machine learning model and based on data accessed from one or more data stores, a data brief that characterizes content from the data stores that is specific to the user category of the user, comprising:
determining a prompt for the generative machine learning model that is based on the user category of the user;
processing a model input that comprises: (i) the prompt based on the user category of the user, and (ii) at least a subset of data stored in the data stores, using the generative machine learning model to generate a model output that is responsive to the prompt; and
including the model output generated by the generative machine learning model in the data brief; and
providing, to the user and by way of the user interface, a representation of the data brief generated using the generative machine learning model.

20. A system comprising:
one or more computers; and
one or more storage devices communicatively coupled to the one or more computers, wherein the one or more storage devices store instructions that, when executed by the one or more computers, cause the one or more computers to perform operations comprising:
determining a user category of a user, wherein the user category is selected from a predefined set of user categories;
generating, using a generative machine learning model and based on data accessed from one or more data stores, a data brief that characterizes content from the data stores that is specific to the user category of the user, comprising:
determining a prompt for the generative machine learning model that is based on the user category of the user;
processing a model input that comprises: (i) the prompt based on the user category of the user, and (ii) at least a subset of data stored in the data stores, using the generative machine learning model to generate a model output that is responsive to the prompt; and
including the model output generated by the generative machine learning model in the data brief; and
providing, to the user and by way of the user interface, a representation of the data brief generated using the generative machine learning model.
